(19) United States
(12) Patent Application Publication
(10) Pub. No.: US 2025/0314502 A1
(43) Pub. Date: Oct. 9, 2025

(54) DETERMINING WAIT CONDITION INFORMATION ASSOCIATED WITH TRAFFIC FEATURES FOR AUTONOMOUS SYSTEMS AND APPLICATIONS

(71) Applicant: NVIDIA Corporation, Santa Clara, CA (US)

(72) Inventors: Andrew Carley, Kenmore, WA (US); Chase Equall, Bozeman, MT (US); Michael Grabner, Redmond, WA (US); Michael Kroepfl, Kirkland, WA (US); Vadims Cugunovs, Bellevue, WA (US)

(21) Appl. No.: 18/627,768

(22) Filed: Apr. 5, 2024

(51) Int. Cl. G01C 21/00

(52) U.S. Cl. CPC G01C 21/3811

(57) ABSTRACT

In various examples, determining wait condition information associated with traffic features for autonomous and semi-autonomous systems and applications is described herein. Systems and methods described herein may process data representing actual driving behaviors associated with users of machines in order to determine wait condition information, such as wait lines (e.g., stopping lines, etc.), for traffic features located within an environment. For instance, mapstreams (e.g., drives, etc.) associated with machines navigating approximate to a traffic feature may be scored based at least on whether rules associated with the environment and/or the traffic feature were followed. At least a portion of the mapstreams, such as mapstreams associated with at least a threshold score, may then be used to determine a wait line associated with the traffic feature. Additionally, map data representative of a map may be updated to indicate the location of the wait line within the environment.

### BACKGROUND

For an autonomous or semi-autonomous vehicle to safely navigate through an environment, the vehicle may rely on maps-such as navigational, standard-definition (SD), and/or high-definition (HD) maps-corresponding to the environment in which the vehicle intends to operate. Due to the detailed, three-dimensional, high precision nature of an HD map, navigating according to the HD map has proven effective for safe navigation of environments where HD map information is available. For example, the vehicle may rely on the map to determine the locations of traffic features, such as lanes, intersections, traffic signals, traffic signs, lane lines, and/or the like located within the environment. The vehicle may then use the locations of these traffic features when determining how to navigate within the environment. For example, when approaching an intersection that includes a traffic signal, the vehicle may use the locations of the intersection, the lane, and/or the traffic signal to determine how to navigate through the intersection.

In some circumstances, an HD map may include additional information associated with an environment, such as areas within the environment that may require vehicles to yield and/or stop. For instance, these areas may be governed by traffic signals, traffic signs, yield signs, crosswalks, and/or other types of traffic controlling features. As such, vehicles may further be required to follow rules associated with the different features when approaching these areas of the environment. For instance, when approaching an intersection that is governed by a traffic light and/or stop sign, it may be important for a vehicle to determine a stopping location. However, based on the layout of the environment surrounding the intersection, it may be difficult for the vehicle to determine the appropriate stopping location, which may reduce the safety of the vehicle and/or pedestrians, and/or may cause problems when navigating through the environment.

### SUMMARY

Embodiments of the present disclosure relate to determining wait condition information associated with traffic features for autonomous and semi-autonomous systems and applications. Systems and methods described herein may process data associated with actual driving behaviors of drivers of machines in order to determine wait condition information, such as wait lines (e.g., yielding lines, stopping lines, etc.), associated with traffic features located within an environment. For instance, mapstreams (e.g., sensor data, perception results, etc. corresponding to drives, etc.) associated with machines navigating approximate to a traffic feature, such as a traffic sign and/or traffic signal, may be scored based at least on whether rules associated with the environment and/or the traffic feature were followed. At least a portion of the mapstreams, such as mapstreams associated with at least a threshold score, may then be used to determine a wait line associated with the traffic feature. In some examples, the wait line may include a physical line within the environment (e.g., a traffic line) while, in some examples, the wait line may include a projected line within the environment. This process may then be repeated in order to determine any number of wait lines for any number of traffic features. Additionally, map data representative of a map may be updated to further indicate the locations of the wait lines within the environment.

In contrast to conventional systems, the systems of the current disclosure, in some embodiments, are able to automatically determine the locations of wait lines for traffic features that are associated with wait conditions and/or are able to update maps to indicate the locations of the wait lines. As such, vehicles that use the maps of the current disclosure are better able to determine how to navigate through areas of the environments that are associated with these traffic features, such as by determining appropriate locations for yielding and/or stopping when required under rules of the environments and/or the traffic features. For instance, and for conventional systems, a vehicle may merely stop at a random location when approaching a traffic feature, such as when the traffic feature is a stop sign and/or a traffic signal that is red. In contrast, by using the maps of the current disclosure, the vehicle may determine the appropriate location to stop, which may increase the safety for users and/or the vehicle, and/or may improve how the vehicle navigates within the environment and with respect to the traffic feature.

### BRIEF DESCRIPTION OF THE DRAWINGS

The present systems and methods for determining wait condition information associated with traffic features for autonomous and semi-autonomous systems and applications are described in detail below with reference to the attached drawing figures, wherein:

FIG. 1 illustrates an example data flow diagram for a process of determining wait condition information associated with traffic features located within an environment, in accordance with some embodiments of the present disclosure;

FIG. 2 illustrates an example of a map associated with an environment that includes wait conditions, in accordance with some embodiments of the present disclosure;

FIG. 3 illustrates an example of associating drives with traffic features, in accordance with some embodiments of the present disclosure;

FIG. 4 illustrates an example of grouping paths associated with a traffic feature located within an environment, in accordance with some embodiments of the present disclosure;

FIG. 5 illustrates an example of determining candidate lines associated with traffic features located within an environment, in accordance with some embodiments of the present disclosure;

FIG. 6 illustrates an example of using paths to determine a location for projecting a wait line within an environment, in accordance with some embodiments of the present disclosure;

FIG. 7 illustrates an example of a map that has been updated to indicate wait lines associated with traffic features, in accordance with some embodiments of the present disclosure;

FIG. 8 illustrates a flow diagram showing a method for determining wait condition information associated with a traffic feature, in accordance with some embodiments of the present disclosure;

FIG. 9 illustrates a flow diagram showing a method for determining a wait line for a traffic feature that is associated with a wait condition, in accordance with some embodiments of the present disclosure;

FIG. 10A is an illustration of an example autonomous vehicle, in accordance with some embodiments of the present disclosure;

FIG. 10B is an example of camera locations and fields of view for the example autonomous vehicle of FIG. 10A, in accordance with some embodiments of the present disclosure;

FIG. 10C is a block diagram of an example system architecture for the example autonomous vehicle of FIG. 10A, in accordance with some embodiments of the present disclosure;

FIG. 10D is a system diagram for communication between cloud-based server(s) and the example autonomous vehicle of FIG. 10A, in accordance with some embodiments of the present disclosure;

FIG. 11 is a block diagram of an example computing device suitable for use in implementing some embodiments of the present disclosure; and

FIG. 12 is a block diagram of an example data center suitable for use in implementing some embodiments of the present disclosure.

### DETAILED DESCRIPTION

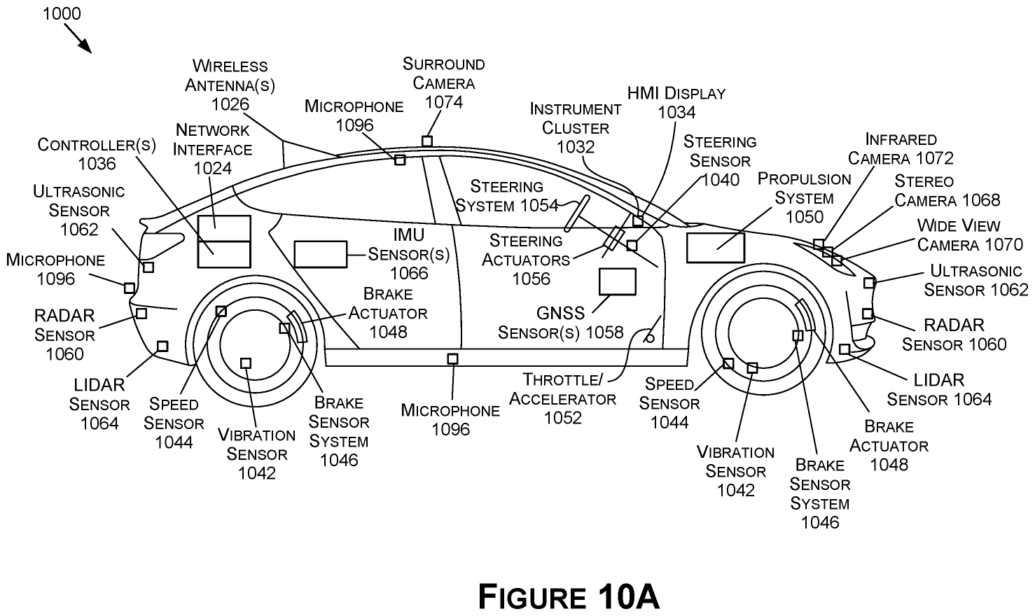

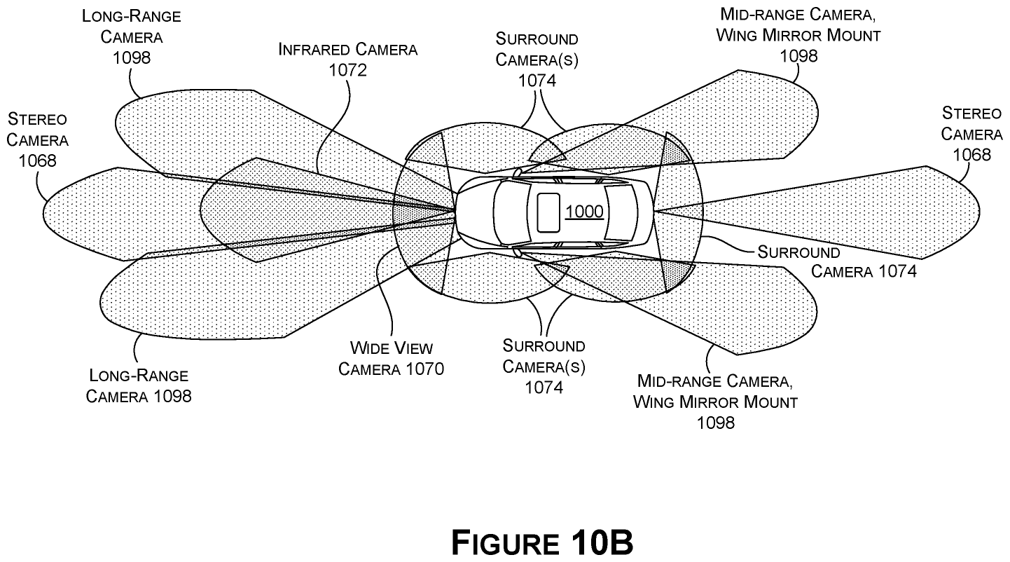

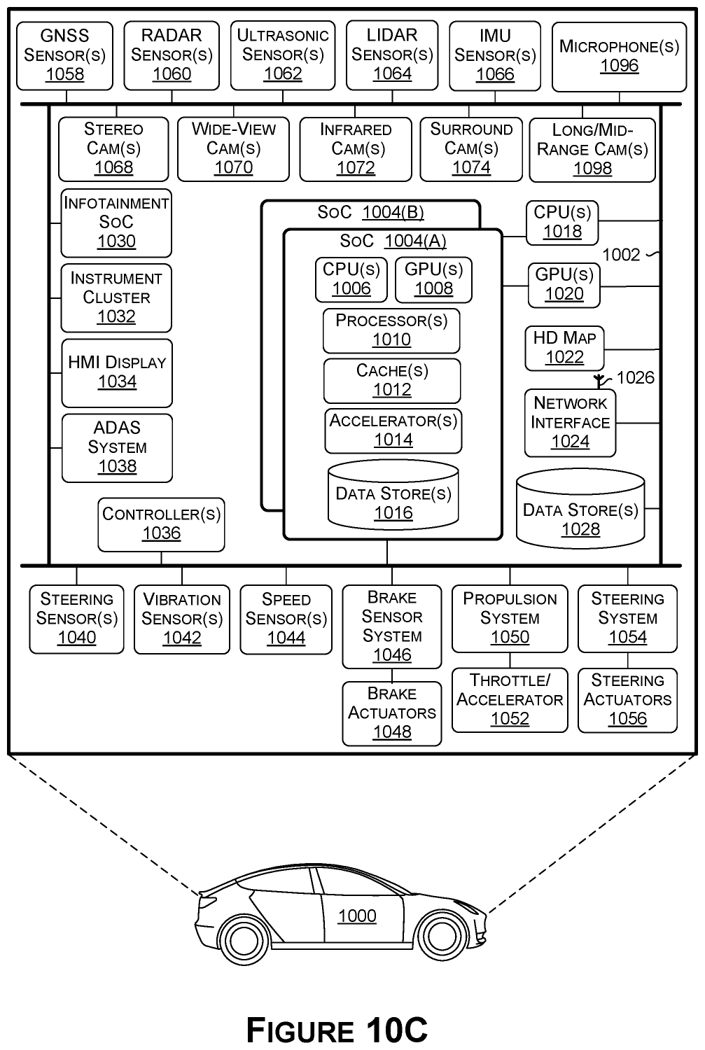

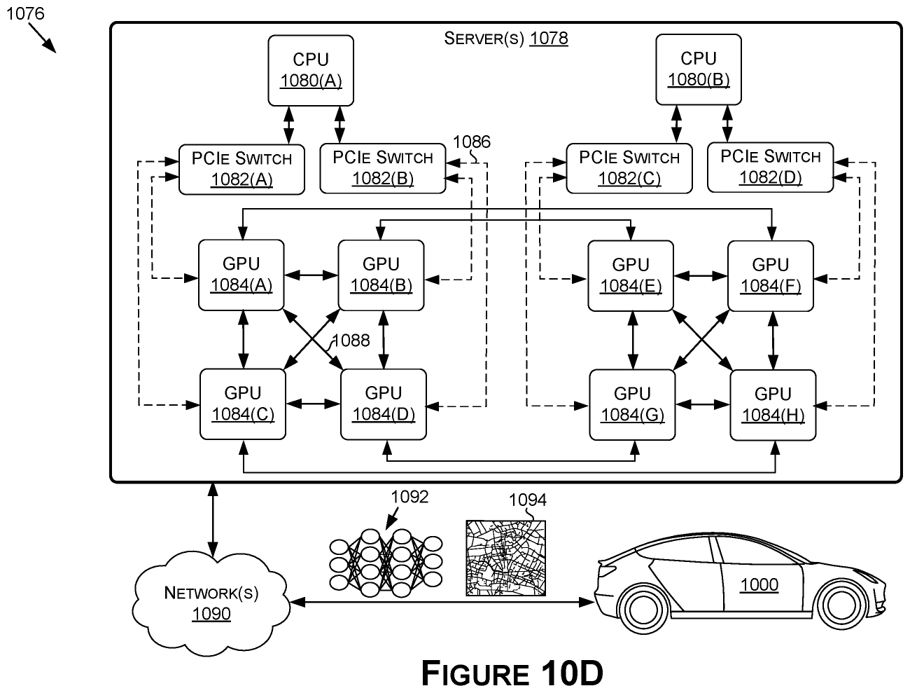

Systems and methods are disclosed related to determining wait condition information associated with traffic features for autonomous and semi-autonomous systems and applications. Although the present disclosure may be described with respect to an example autonomous or semi-autonomous vehicle or machine 1000 (alternatively referred to herein as “vehicle 1000,” “ego-vehicle 1000,” “ego-machine 1000,” or “machine 1000,” an example of which is described with respect to FIGS. 10A-10D), this is not intended to be limiting. For example, the systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. In addition, although the present disclosure may be described with respect to generating and/or updating maps, this is not intended to be limiting, and the systems and methods described herein may be used in augmented reality, virtual reality, mixed reality, robotics, security and surveillance, autonomous or semi-autonomous machine applications, and/or any other technology spaces where object detection and/or map creation may be used.

For instance, a system(s) may generate, receive, retrieve, and/or obtain map data representing a map (e.g., a navigation map, a standard definition (SD) map, a high-definition (HD) map, etc.) of an environment. As described herein, the map may indicate information, such as poses (e.g., locations, orientations, etc.) and/or dimensions, associated with objects located within the environment. For example, the map may indicate poses associated with traffic features such as, but not limited to, traffic signals (e.g., traffic lights), traffic signs, roads, lanes, traffic lines (e.g., lane lines, crosswalk lines, train crossing lines, stopping lines, etc.), intersections, and/or any other type of traffic feature located within the environment. Additionally, in some examples, the map data may represent associations between the objects located within the environment. For example, the map data may represent an association between a traffic feature and a lane, such as by associating a traffic signal, a traffic sign, and/or a traffic line with the lane. Furthermore, in some examples, the map data (and/or other data) may represent rules associated with the environment and/or the objects. For example, the map data may represent directions of travel associated with roads and/or lanes, how to proceed when approaching a traffic feature (e.g., stop at a red light, yield at a yellow light, proceed at a green light, proceed in an indicated direction, etc.), speed limits, stopping durations, and/or any other type of rule.

The system(s) may further receive data (e.g., referred to, in some examples, as “mapstreams” or “drives”) generated using one or more machines (e.g., one or more vehicles) while navigating within the environment. As described herein, a mapstream may include, but is not limited to, a stream of sensor data (e.g., image data, LiDAR data, RADAR data, etc.), perception outputs from one or more neural networks, trajectory outputs indicating paths traveled within the environment (e.g., locations, orientations, etc.), speed information (e.g., velocities, accelerations, etc.), and/or any other data generated by a machine and during a drive. In some examples, at least a portion of the mapstreams may be associated with actual human drivers navigating within the environment. In some examples, at least a portion of the mapstreams may be associated with autonomous machines navigating within the environment.

The system(s) may then use the map data and/or the mapstreams to determine wait condition information associated with the environment. For instance, and for a traffic feature, such as a traffic signal, a traffic sign, and/or any other type of traffic feature that may require a machine to yield and/or stop within the environment, the system(s) may identify one or more mapstreams that are associated with the traffic feature. As described herein, a mapstream may be associated with the traffic feature based at least on (1) a machine associated with the mapstream navigating in a lane associated with the traffic feature, (2) the machine needing to navigate according to the rule(s) associated with the traffic feature, and/or (3) using any other technique. For instance, if the system(s) uses the map data to determine that the traffic feature is associated with a portion of a lane within the environment, and the mapstream indicates that the machine navigated along the portion of the lane, then the system may associate with the mapstream with the traffic feature. In some examples, the system(s) may also crop the mapstream(s), such as removing portions of the mapstream(s) that are not related to the traffic feature (e.g., portions of the mapstream(s) that are outside of a threshold distance to the traffic feature), where the cropped mapstream(s) may be referred to as a drive(s) and/or a path(s).

The system(s) may then determine one or more scores associated with the drive(s) based at least on the rule(s) associated with the traffic feature and/or the environment. For instance, the system(s) may determine a higher score for a drive in which the rule(s) of the environment and/or the traffic feature was followed and a lower score for a drive in which the rule(s) of the environment and/or the traffic feature was not followed. For a first example, if the traffic feature includes a stop sign, then the system(s) may determine a higher score for a drive if a machine decelerated to a stop before the stop sign, waited a period of time, and then accelerated passed the stop sign. For a second example, if the traffic feature again includes a stop sign, then the system(s) may determine a lower score for a drive if a machine does not completely stop while navigating passed the stop sign. In some examples, scores may be associated with a range, such as between 0 and 1 (and/or any other range). For example, a high score may be proximate to a top of the range, such as 1, while a lower score may be proximate to a bottom of the range, such as 0.

The system(s) may then use the drive(s) to determine one or more paths associated with the traffic feature and/or a lane associated with the traffic feature. For example, the system(s) may determine the path(s) as including at least a portion of the drive(s) that is associated with the same lane as the traffic feature. The system(s) may then group and/or merge the path(s) together to generate a final path and/or determine a final score associated with the path(s). For example, the system(s) may determine the final score as the average, the median, the mode, and/or using any other measure associated with the score(s). In some examples, the system(s) may remove one or more of the path(s) when performing the grouping. For example, the system(s) may remove one or more of the path(s) that are associated with one or more scores that do not satisfy (e.g., are less than) a threshold score. In some examples, the system(s) may remove this path(s) since the path(s) does not adequately represent how machines should navigate with respect to the traffic feature. The system(s) may then use the remaining path(s) and/or use the final path that is generated using the remaining path(s) to determine wait condition information associated with the traffic feature.

For instance, in some examples, the system(s) may determine one or more candidate lines that may include a wait line associated with the traffic feature using the map data. As described herein, a candidate line may include a traffic line that at least partially crosses the lane associated with the traffic feature. The system(s) may then select a candidate line from the one or more candidate lines to include as the wait line based at least on the path(s) and/or the final path. For a first example, the system(s) may select the candidate line for which a majority of the path(s) include at least a brief stop when approaching the traffic feature as the wait line. For a second example, the system(s) may select the candidate line for which the final path includes at least a brief stop when approaching the traffic feature as the wait line.

Additionally, or alternatively, in some examples, such as when the map data does not indicate one or more candidate lines and/or the environment does not include any traffic lines that may work as the wait line for the traffic feature, the system(s) may use one or more additional techniques to determine a location of the wait line within the environment. For a first example, the system(s) may project a wait line within the environment at a location for which a majority of the path(s) include at least a brief stop when approaching the traffic feature. For a second example, the system(s) may project a wait line within the environment at a location for which the final path includes at least a brief stop when approaching the traffic feature. In other words, and for any of these examples, the system(s) may use actual driving behaviors associated with one or more drivers within the environment to determine the location of the wait line.

In some examples, the system(s) may perform similar processes to determine wait condition information (e.g., wait lines) associated with additional traffic features located within the environment. Additionally, in some examples, the system(s) may combine two or more of these final paths together in order to determine wait condition information for multiple traffic features located within the environment, such as a specific region of the environment. For example, the system(s) may group final paths together that are associated with a same intersection in order to determine wait condition information for the entire intersection. In such an example, the wait condition information may include wait lines for different traffic features of the intersection, different roads through intersection, different lanes through the intersection, and/or so forth.

As described herein, the system(s) may then update the map data to indicate the wait condition information associated with the traffic feature. In some examples, the system(s) may update the map data by encoding the map data with the wait condition information. Additionally, or alternatively, in some examples, the system(s) may update the map data by generating and/or updating a layer of the map data that is associated with wait conditions. The system(s) may then provide the map data, which is updated with the wait condition information, to one or more machine navigating within the environment. As described herein, since the map data now indicates the wait condition information, the machines navigating within the environment may use the wait condition information to determine locations to stop when approaching traffic features. For a first example, if a machine is approaching a traffic signal that is red, the machine may determine to stop at the wait line associated with the traffic signal. For a second example, if a machine is approaching a stop sign, then the machine may determine to stop at the wait line associated with the stop sign.

The systems and methods described herein may be used by, without limitation, non-autonomous vehicles or machines, semi-autonomous vehicles or machines (e.g., in one or more adaptive driver assistance systems (ADAS)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, underwater craft, drones, and/or other vehicle types. Further, the systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems implementing large language models (LLMs), systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for performing generative AI operations, systems implemented at least partially using cloud computing resources, and/or other types of systems.

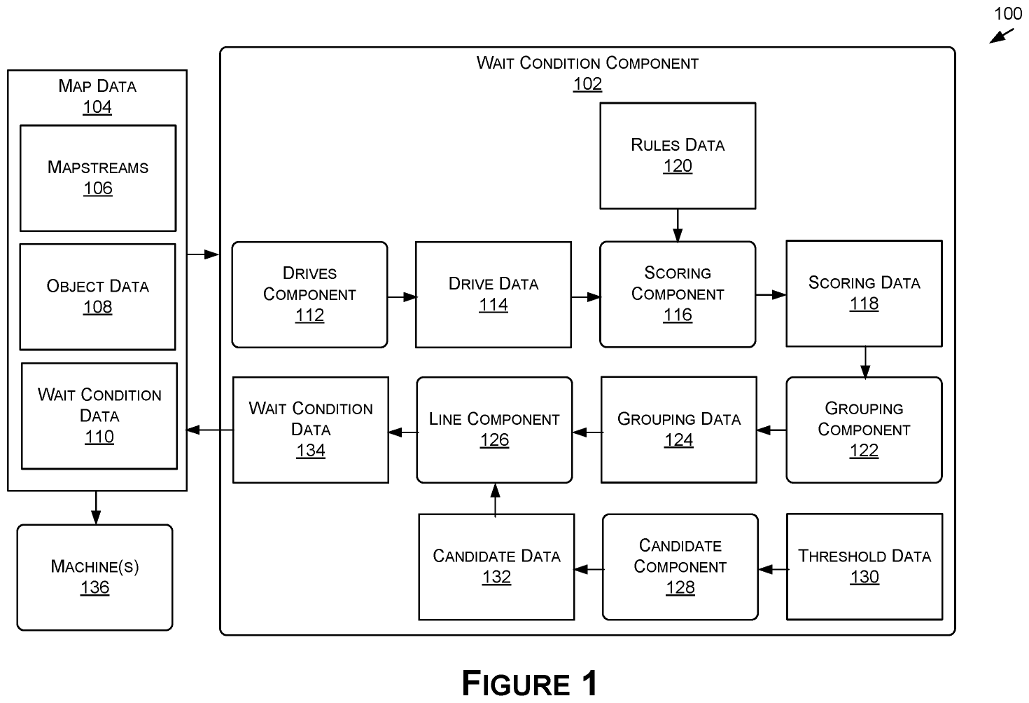

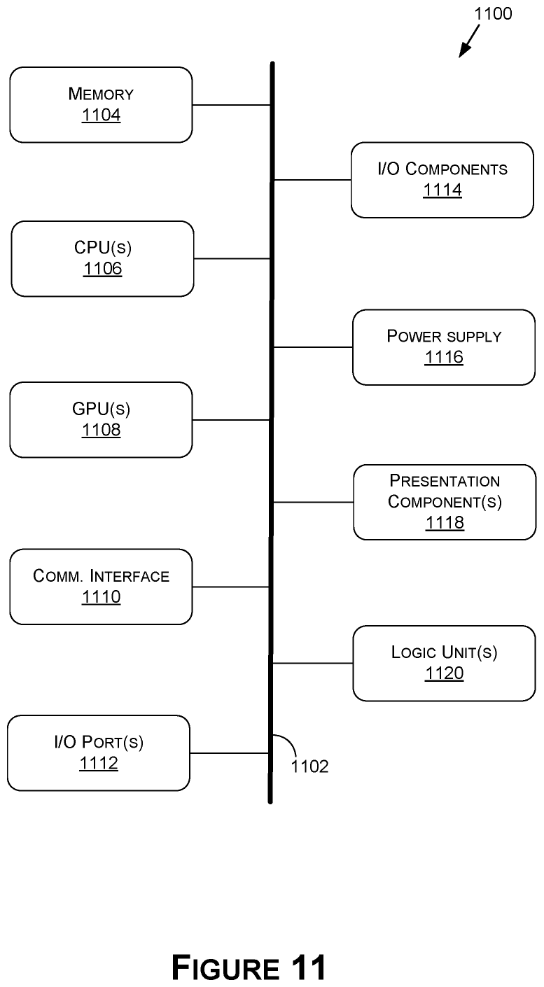

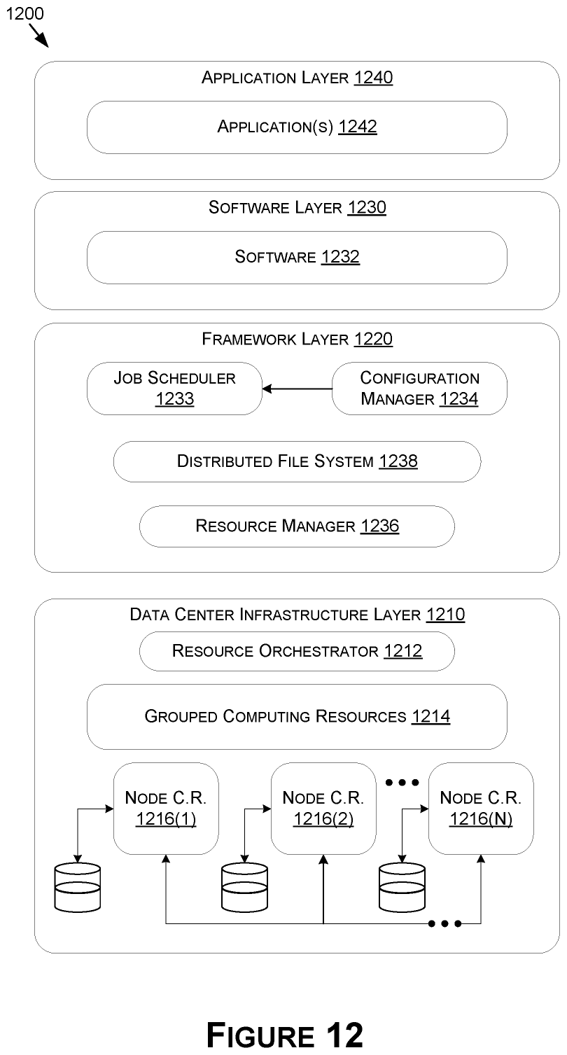

With reference to FIG. 1, FIG. 1 FIG. 1 illustrates an example data flow diagram for a process 100 of determining wait condition information associated with traffic features located within an environment, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. In some embodiments, the systems, methods, and processes described herein may be executed using similar components, features, and/or functionality to those of example autonomous vehicle 1000 of FIGS. 10A-10D, example computing device 1100 of FIG. 11, and/or example data center 1200 of FIG. 12.

The process 100 may include a wait condition component 102 receiving map data 104 representing a map associated with an environment. As shown, the map data 104 may include and/or be associated with at least mapstreams 106, object data 108, and/or wait condition data 110. As described herein, a mapstreams 106 may include, but is not limited to, a stream of sensor data (e.g., image data, LiDAR data, RADAR data, motion data, orientation data, location data, etc.), perception outputs from one or more neural networks, trajectory outputs indicating paths traveled within the environment (e.g., locations, orientations, etc.), speed information (e.g., velocities, accelerations, etc.), and/or any other data generated by a machine during a drive. Additionally, the object data 108 (which, in some examples, may include a portion of the mapstreams 106) may represent information associated with objects located within the environment, such as traffic features (e.g., roads, road lines, traffic signs, traffic signals, wait conditions, parking locations, etc.). As described herein, the information may include, but is not limited to, classifications associated with the objects, poses associated with the object, and/or any other type of information that may be included in a map. For instance, a classification may include road, road line, traffic sign, traffic signal, parking location, sidewalk, curb structure, and/or any other type of object classification. Additionally, a pose associated with an object may include a location (e.g., the x-coordinate location, the y-coordinate location, and/or the z-coordinate location) and/or an orientation (e.g., the roll, the pitch, the yaw) associated with an object.

In some examples, the object data 108 may further represent associations between objects. For a first example, and for an intersection, the object data 108 may represent an association between a first traffic signal and a first lane, a second traffic signal and a second lane, a third traffic signal and a third lane, and/or so forth. In such an example, the associations may indicate that machines are supposed to navigate according to the traffic signals that are associated with the lanes for which the machines are navigating. For a second example, and for a traffic line (e.g., a crosswalk line, etc.), the object data 108 may represent an association between the traffic line and a lane of a road within an environment.

The wait condition data 110 may represent wait condition information associated with wait conditions located within the environment. As described herein, a wait condition may include a location of—or a location of an intersection governed by—a traffic signal, a yield sign, a stop sign, construction, a crosswalk, a train crossing, and/or other type of wait condition that may require a machine to yield and/or stop within the environment. Additionally, as described herein, the wait condition component 102 may use the map data 104 to determine additional information associated with the wait conditions. For example, the wait condition component 102 may use at least the mapstreams 106 representing how machines navigated within the environment to determine at least locations and/or lines for yielding and/or stopping with regard to the traffic features associated with the wait conditions, where these locations and/or lines may be referred to as “wait locations” and/or “wait lines.” In some examples, by using the mapstreams 106, the wait condition component 102 may better determine the actual locations at which machines are expected to stop when approaching the wait conditions.

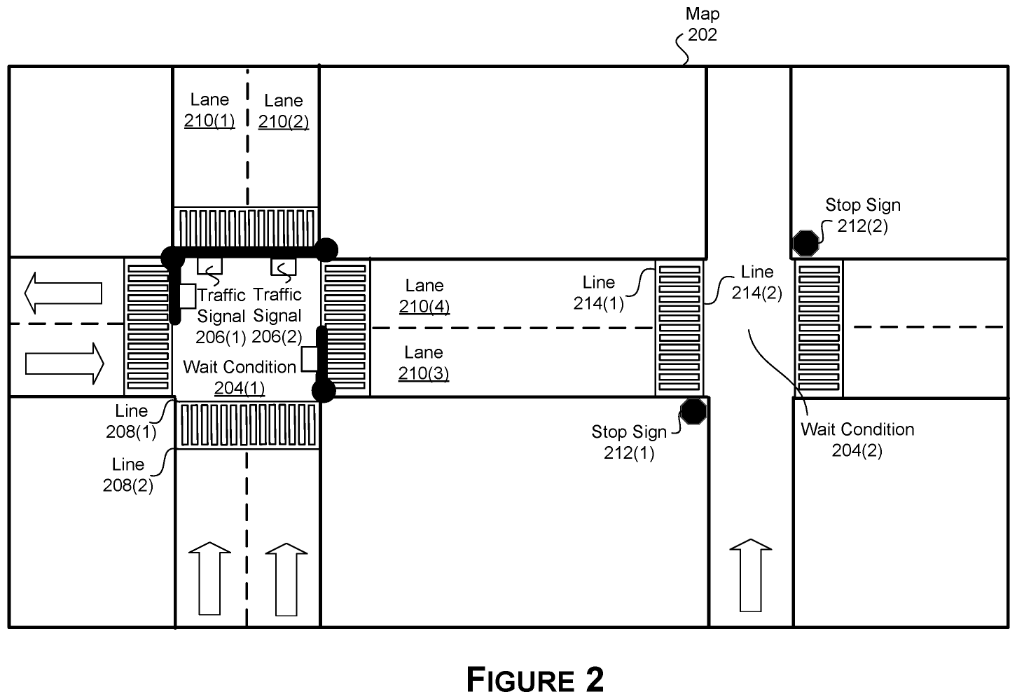

For instance, FIG. 2 illustrates an example of a map 202 associated with an environment that includes wait conditions 204(1)-(2) (also referred to singularly as “wait condition 204” or in plural as “wait conditions 204”), in accordance with some embodiments of the present disclosure. In the example of FIG. 2, the first wait condition 204(1) may be associated with an intersection that includes multiple traffic signals 206(1)-(2) (also referred to singularly as “traffic signal 206” or in plural as “traffic signals 206”), although only two are labeled for clarity reasons, and multiple traffic lines 208(1)-(2) (also referred to singularly as “traffic line 208” or in plural as “traffic lines 208”), although only two are labeled for clarity reasons. Additionally, the map 202 may associate the traffic signals 206 and/or the traffic lines 208 with lanes 210(1)-(4) (also referred to singularly as “lane 210” or in plural as “lanes 210”). For example, the map 202 may indicate that at least the first traffic signal 206(1) is associated with the first lane 210(1), the second traffic signal 206(2) is associated with the second lane 210(2), the third traffic signal is associated with the third lane 210(3), and the fourth traffic signal is associated with the fourth lane 210(4).

Additionally, the second wait condition 204(2) may be associated with an intersection that includes multiple stop signs 212(1)-(2) (also referred to singularly as “stop sign 212” or in plural as “stop signs 212”) and multiple traffic lines 214(1)-(2) (also referred to singularly as “traffic line 214” or in plural as “traffic lines 214”), although only two are labeled for clarity reasons. Additionally, the map 202 may associate the stop signs 212 and/or the traffic lines 214 with lanes 210. For example, the map 202 may indicate that at least the first stop sign 212(1) is associated with the third lane 210(3) and the second stop sign 212(2) is associated with the fourth lane 210(4).

Referring back to the example of FIG. 1, to determine wait condition information associated with a traffic feature, the wait condition component 102 may use a drives component 112 to retrieve one or more mapstreams 106 associated with the traffic feature. As described herein, a mapstream 106 may be associated with the traffic feature based at least on a machine that generated the mapstream 106 navigating along at least a portion of a road and/or a lane that is associated with the traffic feature. For a first example, if the traffic feature includes a stop sign, then the drives component 112 may determine that a mapstream 106 in which a machine navigated along a road associated with the stop sign, such that the machine was supposed to stop at the stop sign, is associated with the stop sign. For a second example, if the traffic feature includes a traffic signal associated with lane of a road, then the drives component 112 may determine that a mapstream 106 in which a machine navigated along the lane, such that the machine was supposed to stop at the traffic signal when red, is associated with the traffic signal.

In some examples, the drives component 112 may perform one or more operations associated with the identified mapstream(s) 106, such as cropping the mapstream(s) 106. For example, and for a mapstream 106, the drives component 112 may crop the mapstream 106 in order to remove portions of the mapstream 106 that are not associated with the traffic feature. As described herein, a portion of the mapstream 106 may not be associated with the traffic feature based at least on the portion of the mapstream 106 being located outside of a threshold distance to the traffic feature, such as 5 meters, 10 meters, 15 meters, and/or any other distance. In other words, after cropping, the mapstream 106 may represent a drive (e.g., a path) that is located within the threshold distance to the traffic feature. This way, the drives component 112 generates and/or outputs drive data 114 representing drives (also referred to, in some examples, as “drive fragments”) that are more related to the traffic feature.

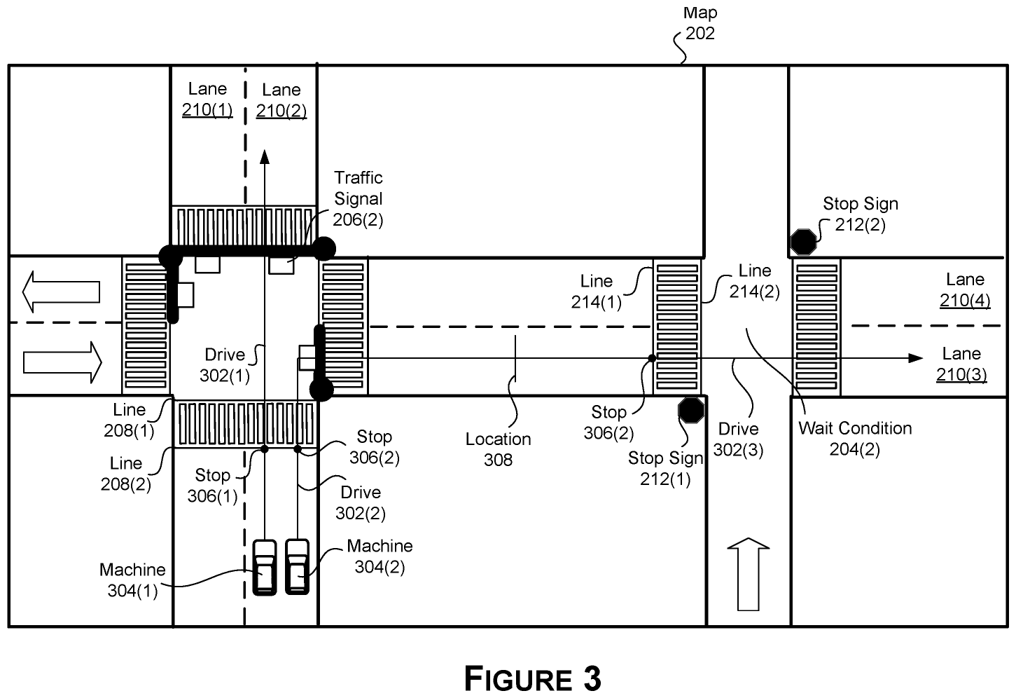

For instance, FIG. 3 illustrates an example of associating drives with traffic features, in accordance with some embodiments of the present disclosure. As shown, the drives component 112 may associate a first drive 302(1) associated with a first machine 304(1) with the second traffic signal 206(2), where the first drive 302(1) occurred at a first time, and a second drive 302(2) associated with a second machine 304(2) with the second traffic signal 206(2), where the second drive 302(2) occurred at a second, different time. As shown, the first drive 302(1) may include at least a first stopping location 306(1) and the second drive 302(2) may include at least a second stopping location 306(2). In some examples, the machines 304(1)-(2) may have stopped during the drives 302(1)-(2) based at least on a state of the second traffic signal 206(2), such that the second traffic signal 206(2) was red.

The drives component 112 may also associate a third drive 302(3) associated with the second machine 304(2) with the first stop sign 212(1). As shown, the third drive 302(3) may include at least a third stopping location 306(3). In the example of FIG. 3, the drives component 112 may have cropped a mapstream associated with the second machine 304(2) in order to generate the second drive 302(2), which starts at a location of the second machine 304(2) and ends at a location 308, and the third drive 302(3), which starts at the location 308 and ends at the end of the arrow.

Referring back to the example of FIG. 1, the process 100 may include the wait condition component 102 using a scoring component 116 to score the drive(s) represented by the drive data 114, where the score(s) is represented by scoring data 118. As described herein, in some examples, the scoring component 116 may score the drive(s) using one or more rules associated with the environment and/or the traffic feature for which the drive(s) is associated, where the rule(s) may be represented by rules data 120 (which, in some examples, may also include a portion of and/or be associated with the map data 104). For a first example, and if the traffic feature includes a stop sign, the rule(s) may include at least stopping at a location that is before the stop sign and/or within a threshold distance before the stop sign. For a second example, and if the traffic feature includes a traffic signal, the rule(s) may include proceeding when the traffic signal is in a green state, yielding when the traffic signal is in a yellow state, stopping when the traffic signal is in a red state, following a direction associated with an arow of the traffic signal, and/or any other rule associated with traffic signals.

In some examples, the scoring component 116 may provide a higher score to drives that follow the rule(s) as compared to drives that do not follow the rule(s). For a first example, and if the traffic feature includes a stop sign, the scoring component 116 may provide a first score to a first drive that includes a first machine slowing down when approaching the stop sign, stopping before the stop sign, and then accelerating past the stop sign. Additionally, the scoring component 116 may provide a second score to a second drive that includes a second machine slowing down when approaching the stop sign, but not coming to a complete stop before accelerating past the stop sign. In this example, the first score may be greater than the second score based at least on the first machine better following the rule(s) associated with the stop sign as compared to the second machine.

For a second example, and if the traffic feature includes a traffic signal, the scoring component 116 may provide a first score to a first drive that includes a first machine slowing down when approaching the traffic signal in a red state, stopping before the traffic signal, and then accelerating past the traffic signal when in a green state and in a direction associated with an arrow of the traffic signal. Additionally, the scoring component 116 may provide a second score to a second drive that includes a second machine slowing down when approaching the traffic signal in a red state, stopping before the traffic signal, and then accelerating past the traffic signal when in a green state, but in a direction that is different than an arrow of the traffic signal. In this example, the first score may be greater than the second score based at least on the first machine better following the rule(s) associated with the traffic signal as compared to the second machine since the first machine followed the direction of the arrow of the traffic signal.

Still, for a third example, and referring back to the example of FIG. 3, the scoring component 116 may determine at least a first score associated with the first drive 302(1) of the first machine 304(1), a second score associated with the second drive 302(2) of the second machine 304(2), and a third score associated with the third drive 302(3) of the second machine 304(2). Additionally, the scoring component 116 may determine the scores for the drives 302(1)-(3) (also referred to singularly as “drive 302” or in plural as “drives 302”) to be high since the machines 304(1)-(2) (also referred to singularly as “machine 304” or in plural as “machines 304”) followed the rules associated with the environment and/or the traffic features.

Referring back to the example of FIG. 1, in some examples, the scoring component 116 may preemptively discard one or more traffic features and/or one or more scores based at least on one or more criteria. For example, the scoring component 116 may discard traffic features and/or scores based at least on a traffic feature not being associated with any mapstreams 106 (e.g., no machine has navigated within the portion of the environment associated with the traffic feature), the states associated with a traffic signal being empty (e.g., the mapstreams 106 associated with the traffic signal do not indicate the colors of the traffic signal), the states associated with the traffic signal satisfying (e.g., being equal to or greater than) a threshold period of time, there is no overlap between the intervals of the traffic signal states and the drives, the traffic signal is not associated with any states, and/or using any other criteria. In other words, the scoring component 116 may preemptively discard scores for drives for which the scoring component 116 may be unable to determine whether the machines correctly followed the rules.

The process 100 may include the wait condition component 102 using a grouping component 122 that associates and/or groups the drive(s) associated with the traffic feature together. For a first example, if the scoring component 116 scores two drives for the same traffic feature, such as two drives that navigate according to rules associated with a stop sign, then the grouping component 122 may associate the two drives together and/or with respect to the traffic feature. For a second example, if the scoring component 116 scores fourth drives for a road that includes two lanes associated with two different traffic signals, then the grouping component 122 may (1) associate two of the drives that are further associated with a first lane with one another and/or a first of the traffic signals and (2) associate two of the paths that are further associated with a second lane with one another and/or a second of the traffic signals. In other words, the grouping component 122 may associate drives together that at least partially overlap with respect to a lane within the environment and/or were affected by the same traffic feature (e.g., the machines associated with the drives navigated according to the rules of the traffic feature). This way, and as described in more detail herein, the wait condition component 102 is able to use the grouped drive(s) to determine wait condition information associated with the traffic feature.

In some examples, the grouping component 122 may perform one or more processes in order to remove one or more of the drive(s) from the group. For instance, the grouping component 122 may remove one or more drives that are associated with one or more scores that do not satisfy (e.g., are less than) a threshold score. For example, if the scores are within a range, such as between 0 and 1, then the grouping component 122 may remove the drive(s) that is associated with a score(s) that is less than 0.9 (e.g., the threshold score). In some examples, the grouping component 122 may perform such processes since the removed drive(s) does not accurately represent how machines should navigate within the environment, such that by following the rule(s) associated with the traffic feature.

In some examples, the grouping component 122 may still perform one or more additional processes. For a first example, the grouping component 122 may merge the drive(s) together to generate a final path associated with the traffic feature. In some examples, merging the drive(s) together may include averaging the drive(s), such as the poses, the velocities, the accelerations, the stopping locations, and/or the like. For a second example, the grouping component 122 may merge the score(s) together to determine a final score associated with the drive(s) and/or the final path. In some examples, merging the score(s) may include taking the average of the score(s), the median of the score(s), the mode of the score(s), and/or performing any other type of mathematical formula associated with the score(s). In any of the examples herein, the grouping component 122 may then generate and/or output grouping data 124 representing the drive(s), the final path, the score(s), and/or the final score.

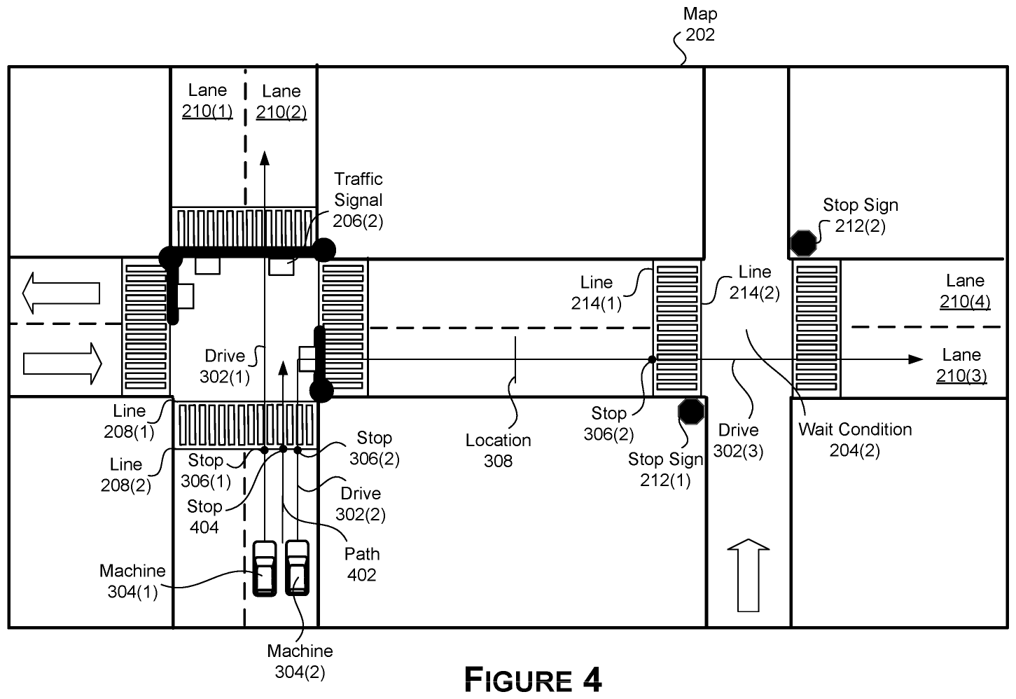

For instance, FIG. 4 illustrates an example of grouping drives associated with a traffic feature located within an environment, in accordance with some embodiments of the present disclosure. In the example of FIG. 4, the grouping component 122 may group the first drive 302(1) associated with the first machine 304(1) with the second drive 302(2) associated with the second machine 304(2) based at least on the drives 302(1)-(2) being associated with the same lane 210(1) and/or the drives 302(1)-(2) being associated with the same traffic signal 206(2). As such, in some examples, the grouping component 122 may merge the scores associated with the drives 302(1)-(2) to determine a final score associated with the grouping. Additionally, in some examples, the grouping component 122 may merge the drives 302(1)-(2) to determine a final path 402 associated with the grouping. As shown, the final path 402 may indicate at least a stopping location 404, such as an average stopping location associated with the drives 302(1)-(2).

Referring back to the example of FIG. 1, the process 100 may include the wait condition component 102 using a line component 126 to determine information for a wait condition associated with the traffic feature. As described herein, in some examples, the wait condition information may include a wait line representing a location within the environment for which machines should yield and/or stop when approaching the traffic feature and based at least on the rules associated with the traffic feature. For a first example, if the traffic feature includes a stop sign, then the wait line may indicate a location within the environment that machines should stop at when approaching the stop sign. For a second example, if the traffic feature includes a traffic signal, then the wait line may indicate a location within the environment that machines should stop at when approaching the traffic signal and when the traffic signal is in a specific state, such as a red light. For a third example, and again if the traffic feature includes a traffic signal, then the wait line may indicate a location within the environment that machines should yield at when approaching the traffic signal and when the traffic signal is in a specific state, such as a yellow light. Still, for a fourth example, if the traffic feature includes a crosswalk light, then the wait line may indicate a location within the environment that machines should stop at when approaching the crosswalk light when the crosswalk light is in a specific state, such as flashing (e.g., indicating that people are crossing).

As described herein, the line component 126 may use one or more techniques for determining the location of the wait line. For instance, in some examples, the wait condition component 102 may use a candidate component 128 that is configured to determine one or more candidate lines that may be used for the wait line. In some examples, the candidate component 128 may determine the candidate lines as including one or more traffic lines that are located within a threshold distance to the traffic feature, where the threshold distance is represented by threshold data 130. As described herein, a traffic line may include, but is not limited to, a stop line, a crosswalk line, a yield line, an intersection entrance line, an intersection exit line, a turn line, a train crossing line, and/or any other line that may be located within the environment. Additionally, a threshold distance may include, but is not limited to, 5 meters, 10 meters, 15 meters, and/or any other distance. In some examples, the candidate component 128 may use the same threshold distance for all traffic features while, in other examples, the candidate component 128 may use different threshold distances for different types of traffic features (e.g., a first threshold distance for traffic signals, a second threshold distance for stop signs, etc.).

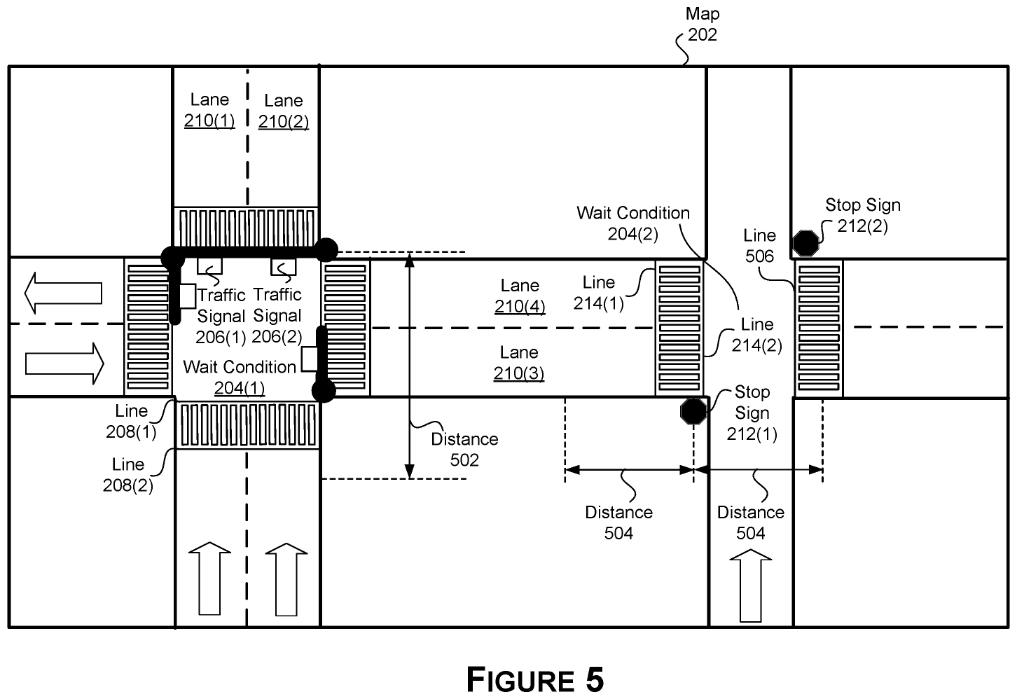

For instance, FIG. 5 illustrates an example of determining candidate lines associated with traffic features located within an environment, in accordance with some embodiments of the present disclosure. As shown, the candidate component 128 may use various techniques to identify the candidate lines. For a first example, and with regard to the second traffic signal 206(2), the candidate component 128 may use a threshold distance 502 from the second traffic signal 206(2) to identify the candidate lines, which include the traffic lines 208 in the example of FIG. 5. For a second example, and with regard to the first stop sign 212(1), the candidate component 128 may use a threshold distance 504 in a first direction from the first stop sign 212(1) to identify candidate lines, which include the traffic line 214(1). Additionally, the candidate component 128 may use the threshold distance 504 in a second direction from the first stop sign 212(1) to identify candidate lines, which include the traffic line 214(2) and another traffic line 506. In some examples, the candidate component 128 may use two threshold distances for the first stop sign 212(1) since, based at least on where stop signs are placed, stop lines may be located before or right after the stop signs.

Referring back to the example of FIG. 1, the line component 126 may receive candidate data 132 representative of one or more candidate lines determined by the candidate component 128. The line component 126 may then use the grouping data 124 and/or the candidate data 132 to select a candidate line, from the candidate line(s), to use as the wait line. For instance, in some examples, such as when the grouping data 124 represents the drive(s) associated with the traffic feature, the line component 126 may select the candidate line for which a majority of the drive(s) stop at within the environment. For example, if the grouping data 124 represents five drives, and four of the drives stop at a first candidate line while one of the drives stops at a second candidate line, then the line component 126 may select the first candidate line as the wait line for the traffic feature. In some examples, such as when the grouping data 124 again represents the drive(s) associated with the traffic feature, the line component 126 may select the candidate line for which a threshold number (e.g., one, five, ten, fifty, one hundred, etc.) of the drive(s) stop at within the environment. For example, if the grouping data 124 represents five drives, four of the drives stop at a first candidate line, one of the drives stops at a second candidate line, and the threshold number is three drives, then the line component 126 may again select the first candidate line as the wait line for the traffic feature.

In some examples, such as when the drive(s) is merged to generate a final path associated with the traffic feature, the line component 126 may select the candidate line for which the final path stops at within the environment. For example, if the candidate data 132 represents two candidate lines, then the line component 126 may select the line for which the final path stops at (and/or is closer in proximity to) as the wait line for the traffic feature. While these are just a few example techniques of how the line component 126 may select a candidate line from among one or more candidate lines to include as a wait line for a traffic feature, in other examples, the line component 126 may use additional and/or alternative techniques.

For instance, and referring back to the example of FIG. 4, in some examples, the line component 126 may select the second traffic line 208(2) to include as the wait line for the second traffic signal 206(2) based at least on a majority of the drives 302 (and/or a threshold number of the drives 302) stopping at the second traffic line 208(2). Additionally, or alternatively, in some examples, the line component 126 may again select the second traffic line 208(2) to include as the wait line for the second traffic signal 206(2) based at least on the final path 402 stopping at the second traffic line 208(2). Additionally, in some examples, the line component 126 may select the first traffic line 214(1) to include as the wait line for the first stop sign 212(1) based at least on a majority of the drives, which only includes the third drive 302(3) in the example of FIG. 4, stopping at the first traffic line 214(1).

Referring back to the example of FIG. 1, in some examples, the line component 126 may use additional and/or alternative techniques to determine a location of the wait line within the environment. For instance, such as if the candidate component 128 is unable to determine candidate lines associated with the traffic feature (e.g., there are no traffic lines within the environment that are within a threshold distance to the traffic feature), then the line component 126 may project a wait line into the environment. For instance, in some examples, such as when the grouping data 124 represents the drive(s) associated with the traffic feature, the line component 126 may project a wait line at a location within the environment for which a majority of the drive(s) stop at within the environment. For example, if the grouping data 124 represents five drives, and four of the drives stop at a first location while one of the drives stops at a second location, then the line component 126 may project the wait line for the traffic feature at the first location.

In some examples, such as when the grouping data 124 again represents the drive(s) associated with the traffic feature, the line component 126 may project a wait line at a location for which a threshold number (e.g., one, five, ten, fifty, one hundred, etc.) of the drive(s) stop at within the environment. For example, if the grouping data 124 represents five drives, four of the drives stop at a first location, one of the drives stops at a second location, and the threshold number is three drives, then the line component 126 may again project the wait line for the traffic feature at the first location. In some examples, such as when the drive(s) is merged to generate a final path associated with the traffic feature, the line component 126 may project a wait line at a location for which the final path stops at within the environment. While these are just a few example techniques of how the line component 126 may determine a location of a projected wait line for a traffic feature, in other examples, the line component 126 may use additional and/or alternative technique.

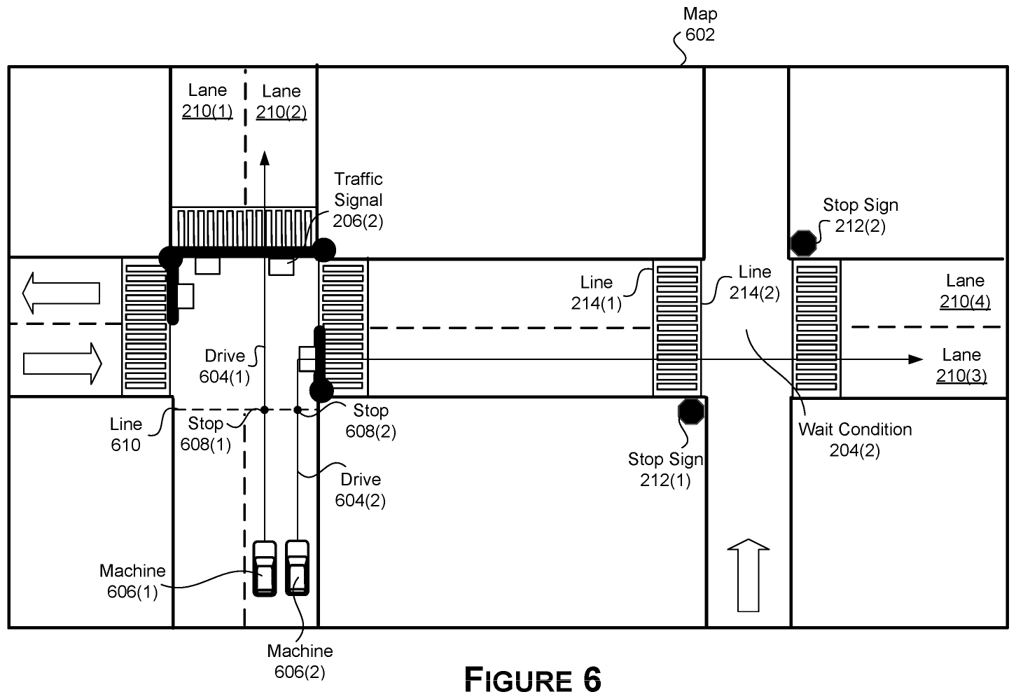

For instance, FIG. 6 illustrates an example of using drives to determine a location for projecting a wait line within an environment, in accordance with some embodiments of the present disclosure. As shown, a map 602 may be similar to the map 202, however, the second lane 210(2) may no longer have the traffic lines 208(1)-(2) associated with the second traffic signal 206(2). As such, the line component 126 may use drives 604(1)-(2) associated with machines 606(1)-(2), which occurred at different time instances, to determine stopping locations 608(1)-(2) associated with the second traffic signal 206(2). The line component 126 may then project a wait line 610 within the environment, where the wait line 610 is located at the stopping locations 608(1)-(2).

Referring back to the example of FIG. 1, the process 100 may include the line component 126 generating and/or outputting updated wait condition data 132 representing the wait condition information, such as the determined wait line. The wait condition component 102 may then update the map data 104 to include the updated wait condition data 132. Additionally, in some examples, the process 100 may continue to repeat to determine wait condition information for any number of traffic features and/or wait conditions within the environment. For instance, the wait condition component 102 may perform these processes in order to determine wait condition information associated with the first traffic signal 206(1) associated with the first lane 210(1), the second traffic signal 206(2) associated with the second lane 210(2), for the third traffic signal associated with the third lane 210(3), the fourth traffic signal associated with the fourth lane 210(4), the first stop sign 212(1) associated with the third lane 210(3), and the second stop sign 212(2) associated with the fourth lane 210(4).

In some examples, the wait condition component 102 may perform additional processes when determining the wait condition information. For instance, the wait condition component 102 may group traffic features together, such as traffic features that are associated with the same wait condition. For example, the wait condition component 102 may group traffic features that are associated with the same intersection and then determine, using one or more of the processes described herein, the wait condition information associated with the group of traffic features.

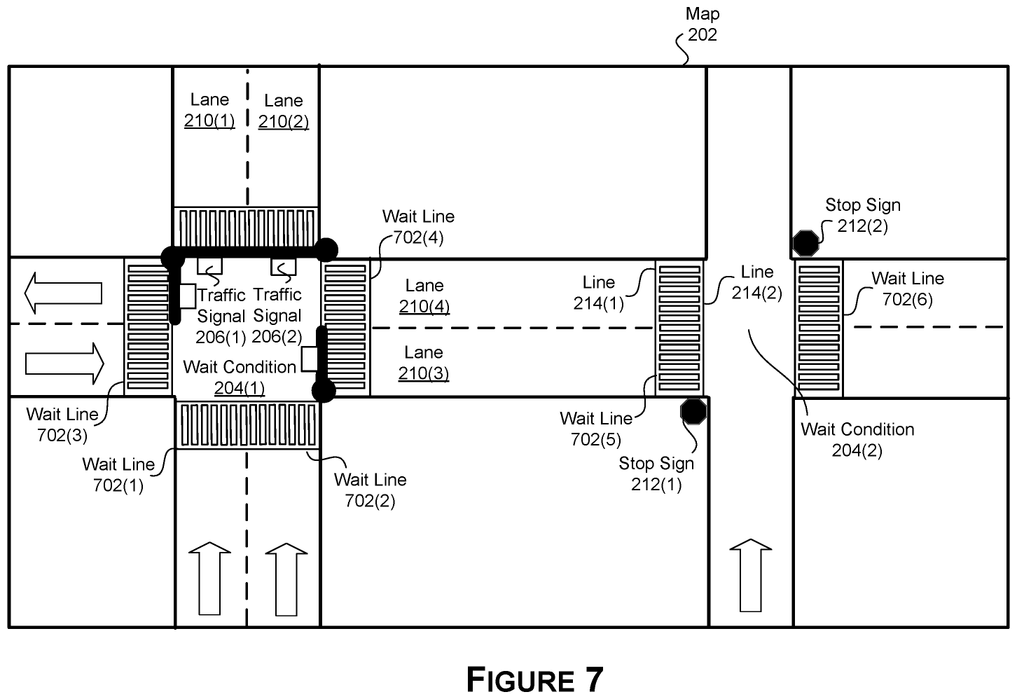

As such, by performing the process 100 of FIG. 1, the wait condition component 102 is able to update the map data 104 in order to indicate additional wait condition information, such as the wait lines for yielding and/or stopping at various traffic features. For instance, FIG. 7 illustrates an example of the map 202 that has been updated to indicate wait lines associated with traffic features, in accordance with some embodiments of the present disclosure.

As shown, the map 202 may now indicate a first wait line 702(1) associated with the first traffic signal 206(1) and/or the first lane 210(1), a second wait line 702(2) associated with the second traffic signal 206(2) and/or the second lane 210(2), a third wait line 702(3) associated with the third traffic signal and/or the third lane 210(3), a fourth wait line 702(4) associated with the fourth traffic signal and/or the fourth lane 210(4), a fifth wait line 702(5) associated with the first stop sign 212(1) and/or the third lane 210(3), and a sixth wait line 702(6) associated with the second stop sign 212(2) and/or the fourth lane 210(4). In other words, by performing the process 100, the wait condition component 102 is able to determine the locations of the wait lines 702(1)-(6) using the traffic lines and then update the map 202 to indicate the locations.

Referring back to the example of FIG. 1, the process 100 may include sending the map data 104, as updated, to one or more machines 136 located within the environment. This way, the machine(s) 136 may use the map data 104 when navigating within the environment, such as to determine where to yield and/or stop with respect to the traffic features. For a first example, if a machine 136 is approaching a stop sign within the environment, then the machine 136 may use the updated map to determine to stop at the wait line associated with the stop sign. For a second example, if a machine 136 is approaching a traffic signal that is in a red state, then the machine 136 may use the updated map to determine to stop at the wait line associated with the traffic signal. Still, for a third example, if a machine 136 is approaching a crosswalk that includes a light signal, and the light signal is in a blinking state indicating that people are crossing, then the machine 136 may use the updated map to determine to stop at the wait line associated with the crosswalk.

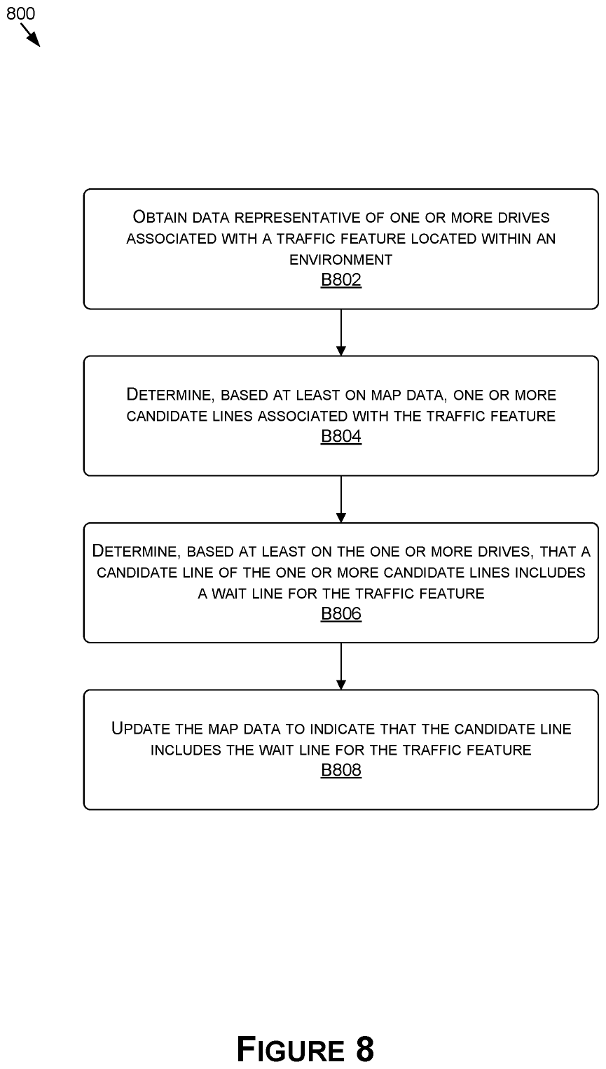

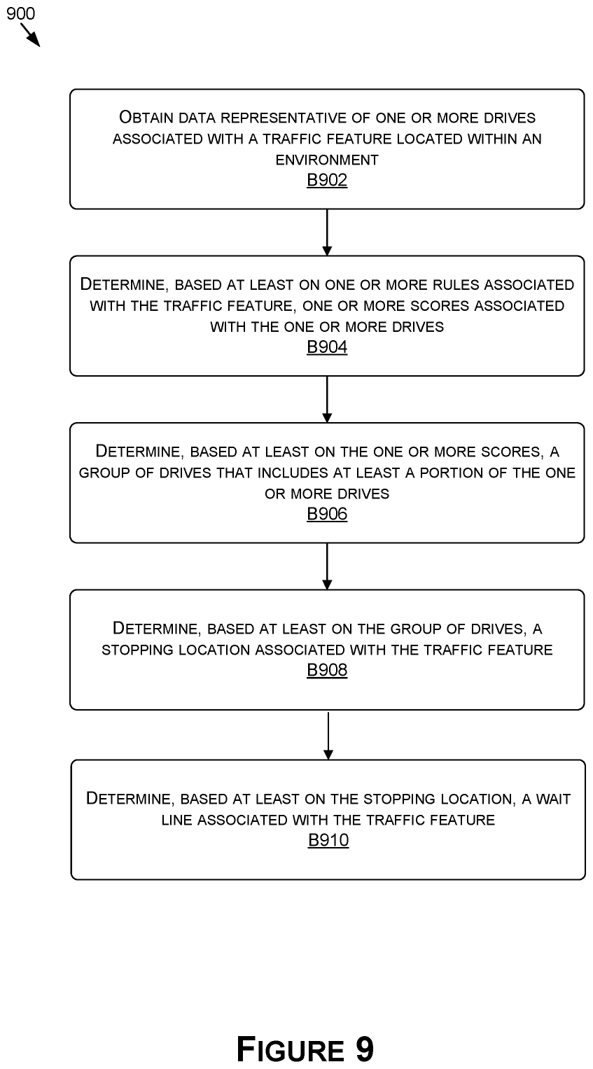

Now referring to FIGS. 8 and 9, each block of methods 800 and 900, described herein, comprises a computing process that may be performed using any combination of hardware, firmware, and/or software. For instance, various functions may be carried out by a processor executing instructions stored in memory. The methods 800 and 900 may also be embodied as computer-usable instructions stored on computer storage media. The methods 800 and 900 may be provided by a standalone application, a service or hosted service (standalone or in combination with another hosted service), or a plug-in to another product, to name a few. In addition, the methods 800 and 900 are described, by way of example, with respect to FIG. 1. However, these methods 800 and 900 may additionally or alternatively be executed by any one system, or any combination of systems, including, but not limited to, those described herein.

FIG. 8 illustrates a flow diagram showing a method 800 for determining wait condition information associated with a traffic feature, in accordance with some embodiments of the present disclosure. The method 800, at block B802, may include obtaining data representative of one or more drives associated with a traffic feature located within an environment. For instance, the wait condition component 102 may receive the mapstreams 106 associated with the environment, where the mapstreams 106 include the data representing the drive(s). In some examples, the wait condition component 102 (e.g., the drives component 112) may crop the drive(s) to include one or more fragments that are associated with the traffic feature, where the fragment(s) may also be referred to as a “path(s)”. In some examples, the wait condition component 102 (e.g., the scoring component 116) may determine one or more scores associated with the drive(s), such as based on how well the drive(s) followed one or more rules associated with the environment and/or the traffic feature.

The process 800, at block B804, may include determining, based at least on map data, one or more candidate lines associated with the traffic feature. For instance, the wait condition component 102 (e.g., the candidate component 128) may use the map data 104 to determine the candidate line(s). As described herein, in some examples, the wait condition component 102 may identity the candidate line(s) based at least on the candidate line(s) being located within a threshold distance to the traffic feature, being associated with a same lane as the traffic feature, being associated with the traffic feature, and/or using any other technique.

The process 800, at block B806, may include determining, based at least on the one or more drives, that a candidate line of the one or more candidate lines includes a wait line for the traffic feature. For instance, the wait condition component 102 (e.g., the line component 126) may select a candidate line from the candidate line(s) as the wait line. As described herein, in some examples, the wait condition component 102 may use one or more techniques to select the candidate line. For a first example, the wait condition component 102 may select the candidate line for which a majority of the drive(s) stop when approaching the traffic feature. For a second example, such as when the wait condition component 102 (e.g., the grouping component 122) merges the drive(s) to generate a final path, the wait condition component 102 may select the candidate line for which the final path stops when approaching the traffic feature.

The method 800, at block B808, may include updating the map data to indicate that the candidate line includes the wait line for the traffic feature. For instance, the wait condition component 102 may use updated wait condition data 134 in order to update the map data 104 to indicate the new wait condition information associated with the traffic feature. As described herein, in some examples, the map data 104 may be updated to indicate that the traffic line, that includes the selected candidate line, is also associated with the wait line for the traffic feature.

FIG. 9 illustrates a flow diagram showing a method 900 for determining a wait line for a traffic feature that is associated with a wait condition, in accordance with some embodiments of the present disclosure. The method 900, at block B902, may include obtaining data representative of one or more drives associated with a traffic feature located within an environment. For instance, the wait condition component 102 may receive the mapstreams 106 associated with the environment, where the mapstreams 106 include the data representing the drive(s). In some examples, the wait condition component 102 (e.g., the drives component 112) may crop the drive(s) to include one or more fragments that are associated with the traffic feature, where the fragment(s) may also be referred to as a “path(s)”.

The method 900, at block B904, may include determining, based at least on one or more rules associated with the traffic feature, one or more scores associated with the one or more drives. For instance, the wait condition component 102 (e.g., the scoring component 116) may determine the score(s) associated with the drive(s). As described herein, the wait condition component 102 may determine the score(s) based at least on how well the drive(s) followed the rule(s) associated with the traffic feature. In some examples, the score(s) may be associated with a range, such as between 0 and 1 (and/or any other range).

The method 900, at block B906, may include determining, based at last on the one or more scores, a group of drives that includes at least a portion of the one or more drives. For instance, the wait condition component 102 (e.g., the grouping component 122) may group the drive(s) based at least on the score(s). As described herein, in some examples, the wait condition component 102 may discard one or more of the drive(s), such as one or more of the drive(s) that is associated with a score(s) that does not satisfy (e.g., is less than) a threshold score. Additionally, in some examples, the wait condition component 102 may merge the drive(s) to generate a final path associated with the traffic feature.

The method 900, at block B908, may include determining, based at least on the group of drives, a stopping location associated with the traffic feature. For instance, the wait condition component 102 (e.g., the line component 126) may determine the stopping location based at least on the group of drives. As described herein, in some examples, the wait condition component 102 may determine the stopping location as being associated with a candidate line of one or more candidate lines associated with the traffic feature. In some examples, the wait condition component 102 may determine the stopping location based at least on a majority of the drive(s) and/or a merged final path stopping at the stopping location.

The method 900, at block B910, may include determining, based at least on the stopping location, a wait line associated with the traffic feature. For instance, the wait condition component 102 (e.g., the line component 126) may determine the wait line based at least on the stopping location. For instance, in some examples, if the stopping location is associated with a candidate line, then the wait condition component 102 may determine that the candidate line includes the wait line. In some examples, if the stopping location is not associated with a candidate line, then the wait condition component 102 may project the wait line at the stopping location. In either example, the wait condition component 102 may then update the map data 104 to indicate the wait line.

### Example Autonomous Vehicle

FIG. 10A is an illustration of an example autonomous vehicle 1000, in accordance with some embodiments of the present disclosure. The autonomous vehicle 1000 (alternatively referred to herein as the “vehicle 1000”) may include, without limitation, a passenger vehicle, such as a car, a truck, a bus, a first responder vehicle, a shuttle, an electric or motorized bicycle, a motorcycle, a fire truck, a police vehicle, an ambulance, a boat, a construction vehicle, an underwater craft, a robotic vehicle, a drone, an airplane, a vehicle coupled to a trailer (e.g., a semi-tractor-trailer truck used for hauling cargo), and/or another type of vehicle (e.g., that is unmanned and/or that accommodates one or more passengers). Autonomous vehicles are generally described in terms of automation levels, defined by the National Highway Traffic Safety Administration (NHTSA), a division of the US Department of Transportation, and the Society of Automotive Engineers (SAE) “Taxonomy and Definitions for Terms Related to Driving Automation Systems for On-Road Motor Vehicles” (Standard No. J3016-201806, published on Jun. 15, 2018, Standard No. J3016-201609, published on Sep. 30, 2016, and previous and future versions of this standard). The vehicle 1000 may be capable of functionality in accordance with one or more of Level 3-Level 5 of the autonomous driving levels. The vehicle 1000 may be capable of functionality in accordance with one or more of Level 1-Level 5 of the autonomous driving levels. For example, the vehicle 1000 may be capable of driver assistance (Level 1), partial automation (Level 2), conditional automation (Level 3), high automation (Level 4), and/or full automation (Level 5), depending on the embodiment. The term “autonomous,” as used herein, may include any and/or all types of autonomy for the vehicle 1000 or other machine, such as being fully autonomous, being highly autonomous, being conditionally autonomous, being partially autonomous, providing assistive autonomy, being semi-autonomous, being primarily autonomous, or other designation.

The vehicle 1000 may include components such as a chassis, a vehicle body, wheels (e.g., 2, 4, 6, 8, 18, etc.), tires, axles, and other components of a vehicle. The vehicle 1000 may include a propulsion system 1050, such as an internal combustion engine, hybrid electric power plant, an all-electric engine, and/or another propulsion system type. The propulsion system 1050 may be connected to a drive train of the vehicle 1000, which may include a transmission, to enable the propulsion of the vehicle 1000. The propulsion system 1050 may be controlled in response to receiving signals from the throttle/accelerator 1052.

A steering system 1054, which may include a steering wheel, may be used to steer the vehicle 1000 (e.g., along a desired path or route) when the propulsion system 1050 is operating (e.g., when the vehicle is in motion). The steering system 1054 may receive signals from a steering actuator 1056. The steering wheel may be optional for full automation (Level 5) functionality.

The brake sensor system 1046 may be used to operate the vehicle brakes in response to receiving signals from the brake actuators 1048 and/or brake sensors.

Controller(s) 1036, which may include one or more system on chips (SoCs) 1004 (FIG. 10C) and/or GPU(s), may provide signals (e.g., representative of commands) to one or more components and/or systems of the vehicle 1000. For example, the controller(s) may send signals to operate the vehicle brakes via one or more brake actuators 1048, to operate the steering system 1054 via one or more steering actuators 1056, to operate the propulsion system 1050 via one or more throttle/accelerators 1052. The controller(s) 1036 may include one or more onboard (e.g., integrated) computing devices (e.g., supercomputers) that process sensor signals, and output operation commands (e.g., signals representing commands) to enable autonomous driving and/or to assist a human driver in driving the vehicle 1000. The controller(s) 1036 may include a first controller 1036 for autonomous driving functions, a second controller 1036 for functional safety functions, a third controller 1036 for artificial intelligence functionality (e.g., computer vision), a fourth controller 1036 for infotainment functionality, a fifth controller 1036 for redundancy in emergency conditions, and/or other controllers. In some examples, a single controller 1036 may handle two or more of the above functionalities, two or more controllers 1036 may handle a single functionality, and/or any combination thereof.

The controller(s) 1036 may provide the signals for controlling one or more components and/or systems of the vehicle 1000 in response to sensor data received from one or more sensors (e.g., sensor inputs). The sensor data may be received from, for example and without limitation, global navigation satellite systems (“GNSS”) sensor(s) 1058 (e.g., Global Positioning System sensor(s)), RADAR sensor(s) 1060, ultrasonic sensor(s) 1062, LIDAR sensor(s) 1064, inertial measurement unit (IMU) sensor(s) 1066 (e.g., accelerometer(s), gyroscope(s), magnetic compass(es), magnetometer(s), etc.), microphone(s) 1096, stereo camera(s) 1068, wide-view camera(s) 1070 (e.g., fisheye cameras), infrared camera(s) 1072, surround camera(s) 1074 (e.g., 360 degree cameras), long-range and/or mid-range camera(s) 1098, speed sensor(s) 1044 (e.g., for measuring the speed of the vehicle 1000), vibration sensor(s) 1042, steering sensor(s) 1040, brake sensor(s) (e.g., as part of the brake sensor system 1046), and/or other sensor types.

One or more of the controller(s) 1036 may receive inputs (e.g., represented by input data) from an instrument cluster 1032 of the vehicle 1000 and provide outputs (e.g., represented by output data, display data, etc.) via a human-machine interface (HMI) display 1034, an audible annunciator, a loudspeaker, and/or via other components of the vehicle 1000. The outputs may include information such as vehicle velocity, speed, time, map data (e.g., the High Definition (“HD”) map 1022 of FIG. 10C), location data (e.g., the vehicle's 1000 location, such as on a map), direction, location of other vehicles (e.g., an occupancy grid), information about objects and status of objects as perceived by the controller(s) 1036, etc. For example, the HMI display 1034 may display information about the presence of one or more objects (e.g., a street sign, caution sign, traffic signal changing, etc.), and/or information about driving maneuvers the vehicle has made, is making, or will make (e.g., changing lanes now, taking exit 34B in two miles, etc.).

The vehicle 1000 further includes a network interface 1024 which may use one or more wireless antenna(s) 1026 and/or modem(s) to communicate over one or more networks. For example, the network interface 1024 may be capable of communication over Long-Term Evolution (“LTE”), Wideband Code Division Multiple Access (“WCDMA”), Universal Mobile Telecommunications System (“UMTS”), Global System for Mobile communication (“GSM”), IMT-CDMA Multi-Carrier (“CDMA2000”), etc. The wireless antenna(s) 1026 may also enable communication between objects in the environment (e.g., vehicles, mobile devices, etc.), using local area network(s), such as Bluetooth, Bluetooth Low Energy (“LE”), Z-Wave, ZigBee, etc., and/or low power wide-area network(s) (“LPWANs”), such as LoRaWAN, SigFox, etc.

FIG. 10B is an example of camera locations and fields of view for the example autonomous vehicle 1000 of FIG. 10A, in accordance with some embodiments of the present disclosure. The cameras and respective fields of view are one example embodiment and are not intended to be limiting. For example, additional and/or alternative cameras may be included and/or the cameras may be located at different locations on the vehicle 1000.

The camera types for the cameras may include, but are not limited to, digital cameras that may be adapted for use with the components and/or systems of the vehicle 1000. The camera(s) may operate at automotive safety integrity level (ASIL) B and/or at another ASIL. The camera types may be capable of any image capture rate, such as 60 frames per second (fps), 120 fps, 240 fps, etc., depending on the embodiment. The cameras may be capable of using rolling shutters, global shutters, another type of shutter, or a combination thereof. In some examples, the color filter array may include a red clear clear clear (RCCC) color filter array, a red clear clear blue (RCCB) color filter array, a red blue green clear (RBGC) color filter array, a Foveon X3 color filter array, a Bayer sensors (RGGB) color filter array, a monochrome sensor color filter array, and/or another type of color filter array. In some embodiments, clear pixel cameras, such as cameras with an RCCC, an RCCB, and/or an RBGC color filter array, may be used in an effort to increase light sensitivity.

In some examples, one or more of the camera(s) may be used to perform advanced driver assistance systems (ADAS) functions (e.g., as part of a redundant or fail-safe design). For example, a Multi-Function Mono Camera may be installed to provide functions including lane departure warning, traffic sign assist and intelligent headlamp control. One or more of the camera(s) (e.g., all of the cameras) may record and provide image data (e.g., video) simultaneously.

One or more of the cameras may be mounted in a mounting assembly, such as a custom designed (three dimensional (“3D”) printed) assembly, in order to cut out stray light and reflections from within the car (e.g., reflections from the dashboard reflected in the windshield mirrors) which may interfere with the camera's image data capture abilities. With reference to wing-mirror mounting assemblies, the wing-mirror assemblies may be custom 3D printed so that the camera mounting plate matches the shape of the wing-mirror. In some examples, the camera(s) may be integrated into the wing-mirror. For side-view cameras, the camera(s) may also be integrated within the four pillars at each corner of the cabin.

Cameras with a field of view that include portions of the environment in front of the vehicle 1000 (e.g., front-facing cameras) may be used for surround view, to help identify forward facing paths and obstacles, as well aid in, with the help of one or more controllers 1036 and/or control SoCs, providing information critical to generating an occupancy grid and/or determining the preferred vehicle paths. Front-facing cameras may be used to perform many of the same ADAS functions as LIDAR, including emergency braking, pedestrian detection, and collision avoidance. Front-facing cameras may also be used for ADAS functions and systems including Lane Departure Warnings (“LDW”), Autonomous Cruise Control (“ACC”), and/or other functions such as traffic sign recognition.

A variety of cameras may be used in a front-facing configuration, including, for example, a monocular camera platform that includes a complementary metal oxide semiconductor (“CMOS”) color imager. Another example may be a wide-view camera(s) 1070 that may be used to perceive objects coming into view from the periphery (e.g., pedestrians, crossing traffic or bicycles). Although only one wide-view camera is illustrated in FIG. 10B, there may be any number (including zero) of wide-view cameras 1070 on the vehicle 1000. In addition, any number of long-range camera(s) 1098 (e.g., a long-view stereo camera pair) may be used for depth-based object detection, especially for objects for which a neural network has not yet been trained. The long-range camera(s) 1098 may also be used for object detection and classification, as well as basic object tracking.

Any number of stereo cameras 1068 may also be included in a front-facing configuration. In at least one embodiment, one or more of stereo camera(s) 1068 may include an integrated control unit comprising a scalable processing unit, which may provide a programmable logic (“FPGA”) and a multi-core micro-processor with an integrated Controller Area Network (“CAN”) or Ethernet interface on a single chip. Such a unit may be used to generate a 3D map of the vehicle's environment, including a distance estimate for all the points in the image. An alternative stereo camera(s) 1068 may include a compact stereo vision sensor(s) that may include two camera lenses (one each on the left and right) and an image processing chip that may measure the distance from the vehicle to the target object and use the generated information (e.g., metadata) to activate the autonomous emergency braking and lane departure warning functions. Other types of stereo camera(s) 1068 may be used in addition to, or alternatively from, those described herein.

Cameras with a field of view that include portions of the environment to the side of the vehicle 1000 (e.g., side-view cameras) may be used for surround view, providing information used to create and update the occupancy grid, as well as to generate side impact collision warnings. For example, surround camera(s) 1074 (e.g., four surround cameras 1074 as illustrated in FIG. 10B) may be positioned to on the vehicle 1000. The surround camera(s) 1074 may include wide-view camera(s) 1070, fisheye camera(s), 360 degree camera(s), and/or the like. Four example, four fisheye cameras may be positioned on the vehicle's front, rear, and sides. In an alternative arrangement, the vehicle may use three surround camera(s) 1074 (e.g., left, right, and rear), and may leverage one or more other camera(s) (e.g., a forward-facing camera) as a fourth surround view camera.

Cameras with a field of view that include portions of the environment to the rear of the vehicle 1000 (e.g., rear-view cameras) may be used for park assistance, surround view, rear collision warnings, and creating and updating the occupancy grid. A wide variety of cameras may be used including, but not limited to, cameras that are also suitable as a front-facing camera(s) (e.g., long-range and/or mid-range camera(s) 1098, stereo camera(s) 1068), infrared camera(s) 1072, etc.), as described herein.

FIG. 10C is a block diagram of an example system architecture for the example autonomous vehicle 1000 of FIG. 10A, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Each of the components, features, and systems of the vehicle 1000 in FIG. 10C are illustrated as being connected via bus 1002. The bus 1002 may include a Controller Area Network (CAN) data interface (alternatively referred to herein as a “CAN bus”). A CAN may be a network inside the vehicle 1000 used to aid in control of various features and functionality of the vehicle 1000, such as actuation of brakes, acceleration, braking, steering, windshield wipers, etc. A CAN bus may be configured to have dozens or even hundreds of nodes, each with its own unique identifier (e.g., a CAN ID). The CAN bus may be read to find steering wheel angle, ground speed, engine revolutions per minute (RPMs), button positions, and/or other vehicle status indicators. The CAN bus may be ASIL B compliant.

Although the bus 1002 is described herein as being a CAN bus, this is not intended to be limiting. For example, in addition to, or alternatively from, the CAN bus, FlexRay and/or Ethernet may be used. Additionally, although a single line is used to represent the bus 1002, this is not intended to be limiting. For example, there may be any number of busses 1002, which may include one or more CAN busses, one or more FlexRay busses, one or more Ethernet busses, and/or one or more other types of busses using a different protocol. In some examples, two or more busses 1002 may be used to perform different functions, and/or may be used for redundancy. For example, a first bus 1002 may be used for collision avoidance functionality and a second bus 1002 may be used for actuation control. In any example, each bus 1002 may communicate with any of the components of the vehicle 1000, and two or more busses 1002 may communicate with the same components. In some examples, each SoC 1004, each controller 1036, and/or each computer within the vehicle may have access to the same input data (e.g., inputs from sensors of the vehicle 1000), and may be connected to a common bus, such the CAN bus.

The vehicle 1000 may include one or more controller(s) 1036, such as those described herein with respect to FIG. 10A. The controller(s) 1036 may be used for a variety of functions. The controller(s) 1036 may be coupled to any of the various other components and systems of the vehicle 1000, and may be used for control of the vehicle 1000, artificial intelligence of the vehicle 1000, infotainment for the vehicle 1000, and/or the like.

The vehicle 1000 may include a system(s) on a chip (SoC) 1004. The SoC 1004 may include CPU(s) 1006, GPU(s) 1008, processor(s) 1010, cache(s) 1012, accelerator(s) 1014, data store(s) 1016, and/or other components and features not illustrated. The SoC(s) 1004 may be used to control the vehicle 1000 in a variety of platforms and systems. For example, the SoC(s) 1004 may be combined in a system (e.g., the system of the vehicle 1000) with an HD map 1022 which may obtain map refreshes and/or updates via a network interface 1024 from one or more servers (e.g., server(s) 1078 of FIG. 10D).

The CPU(s) 1006 may include a CPU cluster or CPU complex (alternatively referred to herein as a “CCPLEX”). The CPU(s) 1006 may include multiple cores and/or L2 caches. For example, in some embodiments, the CPU(s) 1006 may include eight cores in a coherent multi-processor configuration. In some embodiments, the CPU(s) 1006 may include four dual-core clusters where each cluster has a dedicated L2 cache (e.g., a 2 MB L2 cache). The CPU(s) 1006 (e.g., the CCPLEX) may be configured to support simultaneous cluster operation enabling any combination of the clusters of the CPU(s) 1006 to be active at any given time.

The CPU(s) 1006 may implement power management capabilities that include one or more of the following features: individual hardware blocks may be clock-gated automatically when idle to save dynamic power; each core clock may be gated when the core is not actively executing instructions due to execution of WFI/WFE instructions; each core may be independently power-gated; each core cluster may be independently clock-gated when all cores are clock-gated or power-gated; and/or each core cluster may be independently power-gated when all cores are power-gated. The CPU(s) 1006 may further implement an enhanced algorithm for managing power states, where allowed power states and expected wakeup times are specified, and the hardware/microcode determines the best power state to enter for the core, cluster, and CCPLEX. The processing cores may support simplified power state entry sequences in software with the work offloaded to microcode.

The GPU(s) 1008 may include an integrated GPU (alternatively referred to herein as an “iGPU”). The GPU(s) 1008 may be programmable and may be efficient for parallel workloads. The GPU(s) 1008, in some examples, may use an enhanced tensor instruction set. The GPU(s) 1008 may include one or more streaming microprocessors, where each streaming microprocessor may include an L1 cache (e.g., an L1 cache with at least 96 KB storage capacity), and two or more of the streaming microprocessors may share an L2 cache (e.g., an L2 cache with a 512 KB storage capacity). In some embodiments, the GPU(s) 1008 may include at least eight streaming microprocessors. The GPU(s) 1008 may use compute application programming interface(s) (API(s)). In addition, the GPU(s) 1008 may use one or more parallel computing platforms and/or programming models (e.g., NVIDIA's CUDA).

The GPU(s) 1008 may be power-optimized for best performance in automotive and embedded use cases. For example, the GPU(s) 1008 may be fabricated on a Fin field-effect transistor (FinFET). However, this is not intended to be limiting and the GPU(s) 1008 may be fabricated using other semiconductor manufacturing processes. Each streaming microprocessor may incorporate a number of mixed-precision processing cores partitioned into multiple blocks. For example, and without limitation, 64 PF32 cores and 32 PF64 cores may be partitioned into four processing blocks. In such an example, each processing block may be allocated 16 FP32 cores, 8 FP64 cores, 16 INT32 cores, two mixed-precision NVIDIA TENSOR COREs for deep learning matrix arithmetic, an L0 instruction cache, a warp scheduler, a dispatch unit, and/or a 64 KB register file. In addition, the streaming microprocessors may include independent parallel integer and floating-point data paths to provide for efficient execution of workloads with a mix of computation and addressing calculations. The streaming microprocessors may include independent thread scheduling capability to enable finer-grain synchronization and cooperation between parallel threads. The streaming microprocessors may include a combined L1 data cache and shared memory unit in order to improve performance while simplifying programming.

The GPU(s) 1008 may include a high bandwidth memory (HBM) and/or a 16 GB HBM2 memory subsystem to provide, in some examples, about 900 GB/second peak memory bandwidth. In some examples, in addition to, or alternatively from, the HBM memory, a synchronous graphics random-access memory (SGRAM) may be used, such as a graphics double data rate type five synchronous random-access memory (GDDR5).

The GPU(s) 1008 may include unified memory technology including access counters to allow for more accurate migration of memory pages to the processor that accesses them most frequently, thereby improving efficiency for memory ranges shared between processors. In some examples, address translation services (ATS) support may be used to allow the GPU(s) 1008 to access the CPU(s) 1006 page tables directly. In such examples, when the GPU(s) 1008 memory management unit (MMU) experiences a miss, an address translation request may be transmitted to the CPU(s) 1006. In response, the CPU(s) 1006 may look in its page tables for the virtual-to-physical mapping for the address and transmits the translation back to the GPU(s) 1008. As such, unified memory technology may allow a single unified virtual address space for memory of both the CPU(s) 1006 and the GPU(s) 1008, thereby simplifying the GPU(s) 1008 programming and porting of applications to the GPU(s) 1008.

In addition, the GPU(s) 1008 may include an access counter that may keep track of the frequency of access of the GPU(s) 1008 to memory of other processors. The access counter may help ensure that memory pages are moved to the physical memory of the processor that is accessing the pages most frequently.

The SoC(s) 1004 may include any number of cache(s) 1012, including those described herein. For example, the cache(s) 1012 may include an L3 cache that is available to both the CPU(s) 1006 and the GPU(s) 1008 (e.g., that is connected both the CPU(s) 1006 and the GPU(s) 1008). The cache(s) 1012 may include a write-back cache that may keep track of states of lines, such as by using a cache coherence protocol (e.g., MEI, MESI, MSI, etc.). The L3 cache may include 4 MB or more, depending on the embodiment, although smaller cache sizes may be used.

The SoC(s) 1004 may include an arithmetic logic unit(s) (ALU(s)) which may be leveraged in performing processing with respect to any of the variety of tasks or operations of the vehicle 1000—such as processing DNNs. In addition, the SoC(s) 1004 may include a floating point unit(s) (FPU(s))—or other math coprocessor or numeric coprocessor types—for performing mathematical operations within the system. For example, the SoC(s) 104 may include one or more FPUs integrated as execution units within a CPU(s) 1006 and/or GPU(s) 1008.

The SoC(s) 1004 may include one or more accelerators 1014 (e.g., hardware accelerators, software accelerators, or a combination thereof). For example, the SoC(s) 1004 may include a hardware acceleration cluster that may include optimized hardware accelerators and/or large on-chip memory. The large on-chip memory (e.g., 4 MB of SRAM), may enable the hardware acceleration cluster to accelerate neural networks and other calculations. The hardware acceleration cluster may be used to complement the GPU(s) 1008 and to off-load some of the tasks of the GPU(s) 1008 (e.g., to free up more cycles of the GPU(s) 1008 for performing other tasks). As an example, the accelerator(s) 1014 may be used for targeted workloads (e.g., perception, convolutional neural networks (CNNs), etc.) that are stable enough to be amenable to acceleration. The term “CNN,” as used herein, may include all types of CNNs, including region-based or regional convolutional neural networks (RCNNs) and Fast RCNNs (e.g., as used for object detection).

The accelerator(s) 1014 (e.g., the hardware acceleration cluster) may include a deep learning accelerator(s) (DLA). The DLA(s) may include one or more Tensor processing units (TPUs) that may be configured to provide an additional ten trillion operations per second for deep learning applications and inferencing. The TPUs may be accelerators configured to, and optimized for, performing image processing functions (e.g., for CNNs, RCNNs, etc.). The DLA(s) may further be optimized for a specific set of neural network types and floating point operations, as well as inferencing. The design of the DLA(s) may provide more performance per millimeter than a general-purpose GPU, and vastly exceeds the performance of a CPU. The TPU(s) may perform several functions, including a single-instance convolution function, supporting, for example, INT8, INT16, and FP16 data types for both features and weights, as well as post-processor functions.

The DLA(s) may quickly and efficiently execute neural networks, especially CNNs, on processed or unprocessed data for any of a variety of functions, including, for example and without limitation: a CNN for object identification and detection using data from camera sensors; a CNN for distance estimation using data from camera sensors; a CNN for emergency vehicle detection and identification and detection using data from microphones; a CNN for facial recognition and vehicle owner identification using data from camera sensors; and/or a CNN for security and/or safety related events.

The DLA(s) may perform any function of the GPU(s) 1008, and by using an inference accelerator, for example, a designer may target either the DLA(s) or the GPU(s) 1008 for any function. For example, the designer may focus processing of CNNs and floating point operations on the DLA(s) and leave other functions to the GPU(s) 1008 and/or other accelerator(s) 1014.

The accelerator(s) 1014 (e.g., the hardware acceleration cluster) may include a programmable vision accelerator(s) (PVA), which may alternatively be referred to herein as a computer vision accelerator. The PVA(s) may be designed and configured to accelerate computer vision algorithms for the advanced driver assistance systems (ADAS), autonomous driving, and/or augmented reality (AR) and/or virtual reality (VR) applications. The PVA(s) may provide a balance between performance and flexibility. For example, each PVA(s) may include, for example and without limitation, any number of reduced instruction set computer (RISC) cores, direct memory access (DMA), and/or any number of vector processors.

The RISC cores may interact with image sensors (e.g., the image sensors of any of the cameras described herein), image signal processor(s), and/or the like. Each of the RISC cores may include any amount of memory. The RISC cores may use any of a number of protocols, depending on the embodiment. In some examples, the RISC cores may execute a real-time operating system (RTOS). The RISC cores may be implemented using one or more integrated circuit devices, application specific integrated circuits (ASICs), and/or memory devices. For example, the RISC cores may include an instruction cache and/or a tightly coupled RAM.

The DMA may enable components of the PVA(s) to access the system memory independently of the CPU(s) 1006. The DMA may support any number of features used to provide optimization to the PVA including, but not limited to, supporting multi-dimensional addressing and/or circular addressing. In some examples, the DMA may support up to six or more dimensions of addressing, which may include block width, block height, block depth, horizontal block stepping, vertical block stepping, and/or depth stepping.

The vector processors may be programmable processors that may be designed to efficiently and flexibly execute programming for computer vision algorithms and provide signal processing capabilities. In some examples, the PVA may include a PVA core and two vector processing subsystem partitions. The PVA core may include a processor subsystem, DMA engine(s) (e.g., two DMA engines), and/or other peripherals. The vector processing subsystem may operate as the primary processing engine of the PVA, and may include a vector processing unit (VPU), an instruction cache, and/or vector memory (e.g., VMEM). A VPU core may include a digital signal processor such as, for example, a single instruction, multiple data (SIMD), very long instruction word (VLIW) digital signal processor. The combination of the SIMD and VLIW may enhance throughput and speed.

Each of the vector processors may include an instruction cache and may be coupled to dedicated memory. As a result, in some examples, each of the vector processors may be configured to execute independently of the other vector processors. In other examples, the vector processors that are included in a particular PVA may be configured to employ data parallelism. For example, in some embodiments, the plurality of vector processors included in a single PVA may execute the same computer vision algorithm, but on different regions of an image. In other examples, the vector processors included in a particular PVA may simultaneously execute different computer vision algorithms, on the same image, or even execute different algorithms on sequential images or portions of an image. Among other things, any number of PVAs may be included in the hardware acceleration cluster and any number of vector processors may be included in each of the PVAs. In addition, the PVA(s) may include additional error correcting code (ECC) memory, to enhance overall system safety.

The accelerator(s) 1014 (e.g., the hardware acceleration cluster) may include a computer vision network on-chip and SRAM, for providing a high-bandwidth, low latency SRAM for the accelerator(s) 1014. In some examples, the on-chip memory may include at least 4 MB SRAM, consisting of, for example and without limitation, eight field-configurable memory blocks, that may be accessible by both the PVA and the DLA. Each pair of memory blocks may include an advanced peripheral bus (APB) interface, configuration circuitry, a controller, and a multiplexer. Any type of memory may be used. The PVA and DLA may access the memory via a backbone that provides the PVA and DLA with high-speed access to memory. The backbone may include a computer vision network on-chip that interconnects the PVA and the DLA to the memory (e.g., using the APB).

The computer vision network on-chip may include an interface that determines, before transmission of any control signal/address/data, that both the PVA and the DLA provide ready and valid signals. Such an interface may provide for separate phases and separate channels for transmitting control signals/addresses/data, as well as burst-type communications for continuous data transfer. This type of interface may comply with ISO 26262 or IEC 61508 standards, although other standards and protocols may be used.

In some examples, the SoC(s) 1004 may include a real-time ray-tracing hardware accelerator, such as described in U.S. patent application Ser. No. 16/101,232, filed on Aug. 10, 2018. The real-time ray-tracing hardware accelerator may be used to quickly and efficiently determine the positions and extents of objects (e.g., within a world model), to generate real-time visualization simulations, for RADAR signal interpretation, for sound propagation synthesis and/or analysis, for simulation of SONAR systems, for general wave propagation simulation, for comparison to LIDAR data for purposes of localization and/or other functions, and/or for other uses. In some embodiments, one or more tree traversal units (TTUs) may be used for executing one or more ray-tracing related operations.

The accelerator(s) 1014 (e.g., the hardware accelerator cluster) have a wide array of uses for autonomous driving. The PVA may be a programmable vision accelerator that may be used for key processing stages in ADAS and autonomous vehicles. The PVA's capabilities are a good match for algorithmic domains needing predictable processing, at low power and low latency. In other words, the PVA performs well on semi-dense or dense regular computation, even on small data sets, which need predictable run-times with low latency and low power. Thus, in the context of platforms for autonomous vehicles, the PVAs are designed to run classic computer vision algorithms, as they are efficient at object detection and operating on integer math.

For example, according to one embodiment of the technology, the PVA is used to perform computer stereo vision. A semi-global matching-based algorithm may be used in some examples, although this is not intended to be limiting. Many applications for Level 3-5 autonomous driving require motion estimation/stereo matching on-the-fly (e.g., structure from motion, pedestrian recognition, lane detection, etc.). The PVA may perform computer stereo vision function on inputs from two monocular cameras.

In some examples, the PVA may be used to perform dense optical flow. According to process raw RADAR data (e.g., using a 4D Fast Fourier Transform) to provide Processed RADAR. In other examples, the PVA is used for time of flight depth processing, by processing raw time of flight data to provide processed time of flight data, for example.

The DLA may be used to run any type of network to enhance control and driving safety, including for example, a neural network that outputs a measure of confidence for each object detection. Such a confidence value may be interpreted as a probability, or as providing a relative “weight” of each detection compared to other detections. This confidence value enables the system to make further decisions regarding which detections should be considered as true positive detections rather than false positive detections. For example, the system may set a threshold value for the confidence and consider only the detections exceeding the threshold value as true positive detections. In an automatic emergency braking (AEB) system, false positive detections would cause the vehicle to automatically perform emergency braking, which is obviously undesirable. Therefore, only the most confident detections should be considered as triggers for AEB. The DLA may run a neural network for regressing the confidence value. The neural network may take as its input at least some subset of parameters, such as bounding box dimensions, ground plane estimate obtained (e.g. from another subsystem), inertial measurement unit (IMU) sensor 1066 output that correlates with the vehicle 1000 orientation, distance, 3D location estimates of the object obtained from the neural network and/or other sensors (e.g., LIDAR sensor(s) 1064 or RADAR sensor(s) 1060), among others.

The SoC(s) 1004 may include data store(s) 1016 (e.g., memory). The data store(s) 1016 may be on-chip memory of the SoC(s) 1004, which may store neural networks to be executed on the GPU and/or the DLA. In some examples, the data store(s) 1016 may be large enough in capacity to store multiple instances of neural networks for redundancy and safety. The data store(s) 1012 may comprise L2 or L3 cache(s) 1012. Reference to the data store(s) 1016 may include reference to the memory associated with the PVA, DLA, and/or other accelerator(s) 1014, as described herein.

The SoC(s) 1004 may include one or more processor(s) 1010 (e.g., embedded processors). The processor(s) 1010 may include a boot and power management processor that may be a dedicated processor and subsystem to handle boot power and management functions and related security enforcement. The boot and power management processor may be a part of the SoC(s) 1004 boot sequence and may provide runtime power management services. The boot power and management processor may provide clock and voltage programming, assistance in system low power state transitions, management of SoC(s) 1004 thermals and temperature sensors, and/or management of the SoC(s) 1004 power states. Each temperature sensor may be implemented as a ring-oscillator whose output frequency is proportional to temperature, and the SoC(s) 1004 may use the ring-oscillators to detect temperatures of the CPU(s) 1006, GPU(s) 1008, and/or accelerator(s) 1014. If temperatures are determined to exceed a threshold, the boot and power management processor may enter a temperature fault routine and put the SoC(s) 1004 into a lower power state and/or put the vehicle 1000 into a chauffeur to safe stop mode (e.g., bring the vehicle 1000 to a safe stop).

The processor(s) 1010 may further include a set of embedded processors that may serve as an audio processing engine. The audio processing engine may be an audio subsystem that enables full hardware support for multi-channel audio over multiple interfaces, and a broad and flexible range of audio I/O interfaces. In some examples, the audio processing engine is a dedicated processor core with a digital signal processor with dedicated RAM.

The processor(s) 1010 may further include an always on processor engine that may provide necessary hardware features to support low power sensor management and wake use cases. The always on processor engine may include a processor core, a tightly coupled RAM, supporting peripherals (e.g., timers and interrupt controllers), various I/O controller peripherals, and routing logic.

The processor(s) 1010 may further include a safety cluster engine that includes a dedicated processor subsystem to handle safety management for automotive applications. The safety cluster engine may include two or more processor cores, a tightly coupled RAM, support peripherals (e.g., timers, an interrupt controller, etc.), and/or routing logic. In a safety mode, the two or more cores may operate in a lockstep mode and function as a single core with comparison logic to detect any differences between their operations.

The processor(s) 1010 may further include a real-time camera engine that may include a dedicated processor subsystem for handling real-time camera management.

The processor(s) 1010 may further include a high-dynamic range signal processor that may include an image signal processor that is a hardware engine that is part of the camera processing pipeline.

The processor(s) 1010 may include a video image compositor that may be a processing block (e.g., implemented on a microprocessor) that implements video post-processing functions needed by a video playback application to produce the final image for the player window. The video image compositor may perform lens distortion correction on wide-view camera(s) 1070, surround camera(s) 1074, and/or on in-cabin monitoring camera sensors. In-cabin monitoring camera sensor is preferably monitored by a neural network running on another instance of the Advanced SoC, configured to identify in cabin events and respond accordingly. An in-cabin system may perform lip reading to activate cellular service and place a phone call, dictate emails, change the vehicle's destination, activate or change the vehicle's infotainment system and settings, or provide voice-activated web surfing. Certain functions are available to the driver only when the vehicle is operating in an autonomous mode, and are disabled otherwise.

The video image compositor may include enhanced temporal noise reduction for both spatial and temporal noise reduction. For example, where motion occurs in a video, the noise reduction weights spatial information appropriately, decreasing the weight of information provided by adjacent frames. Where an image or portion of an image does not include motion, the temporal noise reduction performed by the video image compositor may use information from the previous image to reduce noise in the current image.

The video image compositor may also be configured to perform stereo rectification on input stereo lens frames. The video image compositor may further be used for user interface composition when the operating system desktop is in use, and the GPU(s) 1008 is not required to continuously render new surfaces. Even when the GPU(s) 1008 is powered on and active doing 3D rendering, the video image compositor may be used to offload the GPU(s) 1008 to improve performance and responsiveness.

The SoC(s) 1004 may further include a mobile industry processor interface (MIPI) camera serial interface for receiving video and input from cameras, a high-speed interface, and/or a video input block that may be used for camera and related pixel input functions. The SoC(s) 1004 may further include an input/output controller(s) that may be controlled by software and may be used for receiving I/O signals that are uncommitted to a specific role.

The SoC(s) 1004 may further include a broad range of peripheral interfaces to enable communication with peripherals, audio codecs, power management, and/or other devices. The SoC(s) 1004 may be used to process data from cameras (e.g., connected over Gigabit Multimedia Serial Link and Ethernet), sensors (e.g., LIDAR sensor(s) 1064, RADAR sensor(s) 1060, etc. that may be connected over Ethernet), data from bus 1002 (e.g., speed of vehicle 1000, steering wheel position, etc.), data from GNSS sensor(s) 1058 (e.g., connected over Ethernet or CAN bus). The SoC(s) 1004 may further include dedicated high-performance mass storage controllers that may include their own DMA engines, and that may be used to free the CPU(s) 1006 from routine data management tasks.

The SoC(s) 1004 may be an end-to-end platform with a flexible architecture that spans automation levels 3-5, thereby providing a comprehensive functional safety architecture that leverages and makes efficient use of computer vision and ADAS techniques for diversity and redundancy, provides a platform for a flexible, reliable driving software stack, along with deep learning tools. The SoC(s) 1004 may be faster, more reliable, and even more energy-efficient and space-efficient than conventional systems. For example, the accelerator(s) 1014, when combined with the CPU(s) 1006, the GPU(s) 1008, and the data store(s) 1016, may provide for a fast, efficient platform for level 3-5 autonomous vehicles.

The technology thus provides capabilities and functionality that cannot be achieved by conventional systems. For example, computer vision algorithms may be executed on CPUs, which may be configured using high-level programming language, such as the C programming language, to execute a wide variety of processing algorithms across a wide variety of visual data. However, CPUs are oftentimes unable to meet the performance requirements of many computer vision applications, such as those related to execution time and power consumption, for example. In particular, many CPUs are unable to execute complex object detection algorithms in real-time, which is a requirement of in-vehicle ADAS applications, and a requirement for practical Level 3-5 autonomous vehicles.

In contrast to conventional systems, by providing a CPU complex, GPU complex, and a hardware acceleration cluster, the technology described herein allows for multiple neural networks to be performed simultaneously and/or sequentially, and for the results to be combined together to enable Level 3-5 autonomous driving functionality. For example, a CNN executing on the DLA or dGPU (e.g., the GPU(s) 1020) may include a text and word recognition, allowing the supercomputer to read and understand traffic signs, including signs for which the neural network has not been specifically trained. The DLA may further include a neural network that is able to identify, interpret, and provides semantic understanding of the sign, and to pass that semantic understanding to the path planning modules running on the CPU Complex.

As another example, multiple neural networks may be run simultaneously, as is required for Level 3, 4, or 5 driving. For example, a warning sign consisting of “Caution: flashing lights indicate icy conditions,” along with an electric light, may be independently or collectively interpreted by several neural networks. The sign itself may be identified as a traffic sign by a first deployed neural network (e.g., a neural network that has been trained), the text “Flashing lights indicate icy conditions” may be interpreted by a second deployed neural network, which informs the vehicle's path planning software (preferably executing on the CPU Complex) that when flashing lights are detected, icy conditions exist. The flashing light may be identified by operating a third deployed neural network over multiple frames, informing the vehicle's path-planning software of the presence (or absence) of flashing lights. All three neural networks may run simultaneously, such as within the DLA and/or on the GPU(s) 1008.

In some examples, a CNN for facial recognition and vehicle owner identification may use data from camera sensors to identify the presence of an authorized driver and/or owner of the vehicle 1000. The always on sensor processing engine may be used to unlock the vehicle when the owner approaches the driver door and turn on the lights, and, in security mode, to disable the vehicle when the owner leaves the vehicle. In this way, the SoC(s) 1004 provide for security against theft and/or carjacking.

In another example, a CNN for emergency vehicle detection and identification may use data from microphones 1096 to detect and identify emergency vehicle sirens. In contrast to conventional systems, that use general classifiers to detect sirens and manually extract features, the SoC(s) 1004 use the CNN for classifying environmental and urban sounds, as well as classifying visual data. In a preferred embodiment, the CNN running on the DLA is trained to identify the relative closing speed of the emergency vehicle (e.g., by using the Doppler Effect). The CNN may also be trained to identify emergency vehicles specific to the local area in which the vehicle is operating, as identified by GNSS sensor(s) 1058. Thus, for example, when operating in Europe the CNN will seek to detect European sirens, and when in the United States the CNN will seek to identify only North American sirens. Once an emergency vehicle is detected, a control program may be used to execute an emergency vehicle safety routine, slowing the vehicle, pulling over to the side of the road, parking the vehicle, and/or idling the vehicle, with the assistance of ultrasonic sensors 1062, until the emergency vehicle(s) passes.

The vehicle may include a CPU(s) 1018 (e.g., discrete CPU(s), or dCPU(s)), that may be coupled to the SoC(s) 1004 via a high-speed interconnect (e.g., PCIe). The CPU(s) 1018 may include an X86 processor, for example. The CPU(s) 1018 may be used to perform any of a variety of functions, including arbitrating potentially inconsistent results between ADAS sensors and the SoC(s) 1004, and/or monitoring the status and health of the controller(s) 1036 and/or infotainment SoC 1030, for example.

The vehicle 1000 may include a GPU(s) 1020 (e.g., discrete GPU(s), or dGPU(s)), that may be coupled to the SoC(s) 1004 via a high-speed interconnect (e.g., NVIDIA's NVLINK). The GPU(s) 1020 may provide additional artificial intelligence functionality, such as by executing redundant and/or different neural networks, and may be used to train and/or update neural networks based on input (e.g., sensor data) from sensors of the vehicle 1000.

The vehicle 1000 may further include the network interface 1024 which may include one or more wireless antennas 1026 (e.g., one or more wireless antennas for different communication protocols, such as a cellular antenna, a Bluetooth antenna, etc.). The network interface 1024 may be used to enable wireless connectivity over the Internet with the cloud (e.g., with the server(s) 1078 and/or other network devices), with other vehicles, and/or with computing devices (e.g., client devices of passengers). To communicate with other vehicles, a direct link may be established between the two vehicles and/or an indirect link may be established (e.g., across networks and over the Internet). Direct links may be provided using a vehicle-to-vehicle communication link. The vehicle-to-vehicle communication link may provide the vehicle 1000 information about vehicles in proximity to the vehicle 1000 (e.g., vehicles in front of, on the side of, and/or behind the vehicle 1000). This functionality may be part of a cooperative adaptive cruise control functionality of the vehicle 1000.

The network interface 1024 may include a SoC that provides modulation and demodulation functionality and enables the controller(s) 1036 to communicate over wireless networks. The network interface 1024 may include a radio frequency front-end for up-conversion from baseband to radio frequency, and down conversion from radio frequency to baseband. The frequency conversions may be performed through well-known processes, and/or may be performed using super-heterodyne processes. In some examples, the radio frequency front end functionality may be provided by a separate chip. The network interface may include wireless functionality for communicating over LTE, WCDMA, UMTS, GSM, CDMA2000, Bluetooth, Bluetooth LE, Wi-Fi, Z-Wave, ZigBee, LoRaWAN, and/or other wireless protocols.

The vehicle 1000 may further include data store(s) 1028 which may include off-chip (e.g., off the SoC(s) 1004) storage. The data store(s) 1028 may include one or more storage elements including RAM, SRAM, DRAM, VRAM, Flash, hard disks, and/or other components and/or devices that may store at least one bit of data.

The vehicle 1000 may further include GNSS sensor(s) 1058. The GNSS sensor(s) 1058 (e.g., GPS, assisted GPS sensors, differential GPS (DGPS) sensors, etc.), to assist in mapping, perception, occupancy grid generation, and/or path planning functions. Any number of GNSS sensor(s) 1058 may be used, including, for example and without limitation, a GPS using a USB connector with an Ethernet to Serial (RS-232) bridge.

The vehicle 1000 may further include RADAR sensor(s) 1060. The RADAR sensor(s) 1060 may be used by the vehicle 1000 for long-range vehicle detection, even in darkness and/or severe weather conditions. RADAR functional safety levels may be ASIL B. The RADAR sensor(s) 1060 may use the CAN and/or the bus 1002 (e.g., to transmit data generated by the RADAR sensor(s) 1060) for control and to access object tracking data, with access to Ethernet to access raw data in some examples. A wide variety of RADAR sensor types may be used. For example, and without limitation, the RADAR sensor(s) 1060 may be suitable for front, rear, and side RADAR use. In some example, Pulse Doppler RADAR sensor(s) are used.

The RADAR sensor(s) 1060 may include different configurations, such as long range with narrow field of view, short range with wide field of view, short range side coverage, etc. In some examples, long-range RADAR may be used for adaptive cruise control functionality. The long-range RADAR systems may provide a broad field of view realized by two or more independent scans, such as within a 250 m range. The RADAR sensor(s) 1060 may help in distinguishing between static and moving objects, and may be used by ADAS systems for emergency brake assist and forward collision warning. Long-range RADAR sensors may include monostatic multimodal RADAR with multiple (e.g., six or more) fixed RADAR antennae and a high-speed CAN and FlexRay interface. In an example with six antennae, the central four antennae may create a focused beam pattern, designed to record the vehicle's 1000 surroundings at higher speeds with minimal interference from traffic in adjacent lanes. The other two antennae may expand the field of view, making it possible to quickly detect vehicles entering or leaving the vehicle's 1000 lane.

Mid-range RADAR systems may include, as an example, a range of up to 1060 m (front) or 80 m (rear), and a field of view of up to 42 degrees (front) or 1050 degrees (rear). Short-range RADAR systems may include, without limitation, RADAR sensors designed to be installed at both ends of the rear bumper. When installed at both ends of the rear bumper, such a RADAR sensor systems may create two beams that constantly monitor the blind spot in the rear and next to the vehicle.

Short-range RADAR systems may be used in an ADAS system for blind spot detection and/or lane change assist.

The vehicle 1000 may further include ultrasonic sensor(s) 1062. The ultrasonic sensor(s) 1062, which may be positioned at the front, back, and/or the sides of the vehicle 1000, may be used for park assist and/or to create and update an occupancy grid. A wide variety of ultrasonic sensor(s) 1062 may be used, and different ultrasonic sensor(s) 1062 may be used for different ranges of detection (e.g., 2.5 m, 4 m). The ultrasonic sensor(s) 1062 may operate at functional safety levels of ASIL B.

The vehicle 1000 may include LIDAR sensor(s) 1064. The LIDAR sensor(s) 1064 may be used for object and pedestrian detection, emergency braking, collision avoidance, and/or other functions. The LIDAR sensor(s) 1064 may be functional safety level ASIL B. In some examples, the vehicle 1000 may include multiple LIDAR sensors 1064 (e.g., two, four, six, etc.) that may use Ethernet (e.g., to provide data to a Gigabit Ethernet switch).

In some examples, the LIDAR sensor(s) 1064 may be capable of providing a list of objects and their distances for a 360-degree field of view. Commercially available LIDAR sensor(s) 1064 may have an advertised range of approximately 1000 m, with an accuracy of 2 cm-3 cm, and with support for a 1000 Mbps Ethernet connection, for example. In some examples, one or more non-protruding LIDAR sensors 1064 may be used. In such examples, the LIDAR sensor(s) 1064 may be implemented as a small device that may be embedded into the front, rear, sides, and/or corners of the vehicle 1000. The LIDAR sensor(s) 1064, in such examples, may provide up to a 120-degree horizontal and 35-degree vertical field-of-view, with a 200 m range even for low-reflectivity objects. Front-mounted LIDAR sensor(s) 1064 may be configured for a horizontal field of view between 45 degrees and 135 degrees.

In some examples, LIDAR technologies, such as 3D flash LIDAR, may also be used. 3D Flash LIDAR uses a flash of a laser as a transmission source, to illuminate vehicle surroundings up to approximately 200 m. A flash LIDAR unit includes a receptor, which records the laser pulse transit time and the reflected light on each pixel, which in turn corresponds to the range from the vehicle to the objects. Flash LIDAR may allow for highly accurate and distortion-free images of the surroundings to be generated with every laser flash. In some examples, four flash LIDAR sensors may be deployed, one at each side of the vehicle 1000. Available 3D flash LIDAR systems include a solid-state 3D staring array LIDAR camera with no moving parts other than a fan (e.g., a non-scanning LIDAR device). The flash LIDAR device may use a 5 nanosecond class I (eye-safe) laser pulse per frame and may capture the reflected laser light in the form of 3D range point clouds and co-registered intensity data. By using flash LIDAR, and because flash LIDAR is a solid-state device with no moving parts, the LIDAR sensor(s) 1064 may be less susceptible to motion blur, vibration, and/or shock.

The vehicle may further include IMU sensor(s) 1066. The IMU sensor(s) 1066 may be located at a center of the rear axle of the vehicle 1000, in some examples. The IMU sensor(s) 1066 may include, for example and without limitation, an accelerometer(s), a magnetometer(s), a gyroscope(s), a magnetic compass(es), and/or other sensor types. In some examples, such as in six-axis applications, the IMU sensor(s) 1066 may include accelerometers and gyroscopes, while in nine-axis applications, the IMU sensor(s) 1066 may include accelerometers, gyroscopes, and magnetometers.

In some embodiments, the IMU sensor(s) 1066 may be implemented as a miniature, high performance GPS-Aided Inertial Navigation System (GPS/INS) that combines micro-electro-mechanical systems (MEMS) inertial sensors, a high-sensitivity GPS receiver, and advanced Kalman filtering algorithms to provide estimates of position, velocity, and attitude. As such, in some examples, the IMU sensor(s) 1066 may enable the vehicle 1000 to estimate heading without requiring input from a magnetic sensor by directly observing and correlating the changes in velocity from GPS to the IMU sensor(s) 1066. In some examples, the IMU sensor(s) 1066 and the GNSS sensor(s) 1058 may be combined in a single integrated unit.

The vehicle may include microphone(s) 1096 placed in and/or around the vehicle 1000. The microphone(s) 1096 may be used for emergency vehicle detection and identification, among other things.

The vehicle may further include any number of camera types, including stereo camera(s) 1068, wide-view camera(s) 1070, infrared camera(s) 1072, surround camera(s) 1074, long-range and/or mid-range camera(s) 1098, and/or other camera types. The cameras may be used to capture image data around an entire periphery of the vehicle 1000. The types of cameras used depends on the embodiments and requirements for the vehicle 1000, and any combination of camera types may be used to provide the necessary coverage around the vehicle 1000. In addition, the number of cameras may differ depending on the embodiment. For example, the vehicle may include six cameras, seven cameras, ten cameras, twelve cameras, and/or another number of cameras. The cameras may support, as an example and without limitation, Gigabit Multimedia Serial Link (GMSL) and/or Gigabit Ethernet. Each of the camera(s) is described with more detail herein with respect to FIG. 10A and FIG. 10B.

The vehicle 1000 may further include vibration sensor(s) 1042. The vibration sensor(s) 1042 may measure vibrations of components of the vehicle, such as the axle(s). For example, changes in vibrations may indicate a change in road surfaces. In another example, when two or more vibration sensors 1042 are used, the differences between the vibrations may be used to determine friction or slippage of the road surface (e.g., when the difference in vibration is between a power-driven axle and a freely rotating axle).

The vehicle 1000 may include an ADAS system 1038. The ADAS system 1038 may include a SoC, in some examples. The ADAS system 1038 may include autonomous/adaptive/automatic cruise control (ACC), cooperative adaptive cruise control (CACC), forward crash warning (FCW), automatic emergency braking (AEB), lane departure warnings (LDW), lane keep assist (LKA), blind spot warning (BSW), rear cross-traffic warning (RCTW), collision warning systems (CWS), lane centering (LC), and/or other features and functionality.

The ACC systems may use RADAR sensor(s) 1060, LIDAR sensor(s) 1064, and/or a camera(s). The ACC systems may include longitudinal ACC and/or lateral ACC. Longitudinal ACC monitors and controls the distance to the vehicle immediately ahead of the vehicle 1000 and automatically adjust the vehicle speed to maintain a safe distance from vehicles ahead. Lateral ACC performs distance keeping, and advises the vehicle 1000 to change lanes when necessary. Lateral ACC is related to other ADAS applications such as LCA and CWS.

CACC uses information from other vehicles that may be received via the network interface 1024 and/or the wireless antenna(s) 1026 from other vehicles via a wireless link, or indirectly, over a network connection (e.g., over the Internet). Direct links may be provided by a vehicle-to-vehicle (V2V) communication link, while indirect links may be infrastructure-to-vehicle (I2V) communication link. In general, the V2V communication concept provides information about the immediately preceding vehicles (e.g., vehicles immediately ahead of and in the same lane as the vehicle 1000), while the I2V communication concept provides information about traffic further ahead. CACC systems may include either or both I2V and V2V information sources. Given the information of the vehicles ahead of the vehicle 1000, CACC may be more reliable and it has potential to improve traffic flow smoothness and reduce congestion on the road.

FCW systems are designed to alert the driver to a hazard, so that the driver may take corrective action. FCW systems use a front-facing camera and/or RADAR sensor(s) 1060, coupled to a dedicated processor, DSP, FPGA, and/or ASIC, that is electrically coupled to driver feedback, such as a display, speaker, and/or vibrating component. FCW systems may provide a warning, such as in the form of a sound, visual warning, vibration and/or a quick brake pulse.

AEB systems detect an impending forward collision with another vehicle or other object, and may automatically apply the brakes if the driver does not take corrective action within a specified time or distance parameter. AEB systems may use front-facing camera(s) and/or RADAR sensor(s) 1060, coupled to a dedicated processor, DSP, FPGA, and/or ASIC. When the AEB system detects a hazard, it typically first alerts the driver to take corrective action to avoid the collision and, if the driver does not take corrective action, the AEB system may automatically apply the brakes in an effort to prevent, or at least mitigate, the impact of the predicted collision. AEB systems, may include techniques such as dynamic brake support and/or crash imminent braking.

LDW systems provide visual, audible, and/or tactile warnings, such as steering wheel or seat vibrations, to alert the driver when the vehicle 1000 crosses lane markings. A LDW system does not activate when the driver indicates an intentional lane departure, by activating a turn signal. LDW systems may use front-side facing cameras, coupled to a dedicated processor, DSP, FPGA, and/or ASIC, that is electrically coupled to driver feedback, such as a display, speaker, and/or vibrating component.

LKA systems are a variation of LDW systems. LKA systems provide steering input or braking to correct the vehicle 1000 if the vehicle 1000 starts to exit the lane.

BSW systems detects and warn the driver of vehicles in an automobile's blind spot. BSW systems may provide a visual, audible, and/or tactile alert to indicate that merging or changing lanes is unsafe. The system may provide an additional warning when the driver uses a turn signal. BSW systems may use rear-side facing camera(s) and/or RADAR sensor(s) 1060, coupled to a dedicated processor, DSP, FPGA, and/or ASIC, that is electrically coupled to driver feedback, such as a display, speaker, and/or vibrating component.

RCTW systems may provide visual, audible, and/or tactile notification when an object is detected outside the rear-camera range when the vehicle 1000 is backing up. Some RCTW systems include AEB to ensure that the vehicle brakes are applied to avoid a crash. RCTW systems may use one or more rear-facing RADAR sensor(s) 1060, coupled to a dedicated processor, DSP, FPGA, and/or ASIC, that is electrically coupled to driver feedback, such as a display, speaker, and/or vibrating component.

Conventional ADAS systems may be prone to false positive results which may be annoying and distracting to a driver, but typically are not catastrophic, because the ADAS systems alert the driver and allow the driver to decide whether a safety condition truly exists and act accordingly. However, in an autonomous vehicle 1000, the vehicle 1000 itself must, in the case of conflicting results, decide whether to heed the result from a primary computer or a secondary computer (e.g., a first controller 1036 or a second controller 1036). For example, in some embodiments, the ADAS system 1038 may be a backup and/or secondary computer for providing perception information to a backup computer rationality module. The backup computer rationality monitor may run a redundant diverse software on hardware components to detect faults in perception and dynamic driving tasks. Outputs from the ADAS system 1038 may be provided to a supervisory MCU. If outputs from the primary computer and the secondary computer conflict, the supervisory MCU must determine how to reconcile the conflict to ensure safe operation.

In some examples, the primary computer may be configured to provide the supervisory MCU with a confidence score, indicating the primary computer's confidence in the chosen result. If the confidence score exceeds a threshold, the supervisory MCU may follow the primary computer's direction, regardless of whether the secondary computer provides a conflicting or inconsistent result. Where the confidence score does not meet the threshold, and where the primary and secondary computer indicate different results (e.g., the conflict), the supervisory MCU may arbitrate between the computers to determine the appropriate outcome.

The supervisory MCU may be configured to run a neural network(s) that is trained and configured to determine, based on outputs from the primary computer and the secondary computer, conditions under which the secondary computer provides false alarms. Thus, the neural network(s) in the supervisory MCU may learn when the secondary computer's output may be trusted, and when it cannot. For example, when the secondary computer is a RADAR-based FCW system, a neural network(s) in the supervisory MCU may learn when the FCW system is identifying metallic objects that are not, in fact, hazards, such as a drainage grate or manhole cover that triggers an alarm. Similarly, when the secondary computer is a camera-based LDW system, a neural network in the supervisory MCU may learn to override the LDW when bicyclists or pedestrians are present and a lane departure is, in fact, the safest maneuver. In embodiments that include a neural network(s) running on the supervisory MCU, the supervisory MCU may include at least one of a DLA or GPU suitable for running the neural network(s) with associated memory. In preferred embodiments, the supervisory MCU may comprise and/or be included as a component of the SoC(s) 1004.

In other examples, ADAS system 1038 may include a secondary computer that performs ADAS functionality using traditional rules of computer vision. As such, the secondary computer may use classic computer vision rules (if-then), and the presence of a neural network(s) in the supervisory MCU may improve reliability, safety and performance. For example, the diverse implementation and intentional non-identity makes the overall system more fault-tolerant, especially to faults caused by software (or software-hardware interface) functionality. For example, if there is a software bug or error in the software running on the primary computer, and the non-identical software code running on the secondary computer provides the same overall result, the supervisory MCU may have greater confidence that the overall result is correct, and the bug in software or hardware on primary computer is not causing material error.

In some examples, the output of the ADAS system 1038 may be fed into the primary computer's perception block and/or the primary computer's dynamic driving task block. For example, if the ADAS system 1038 indicates a forward crash warning due to an object immediately ahead, the perception block may use this information when identifying objects. In other examples, the secondary computer may have its own neural network which is trained and thus reduces the risk of false positives, as described herein.

The vehicle 1000 may further include the infotainment SoC 1030 (e.g., an in-vehicle infotainment system (IVI)). Although illustrated and described as a SoC, the infotainment system may not be a SoC, and may include two or more discrete components. The infotainment SoC 1030 may include a combination of hardware and software that may be used to provide audio (e.g., music, a personal digital assistant, navigational instructions, news, radio, etc.), video (e.g., TV, movies, streaming, etc.), phone (e.g., hands-free calling), network connectivity (e.g., LTE, Wi-Fi, etc.), and/or information services (e.g., navigation systems, rear-parking assistance, a radio data system, vehicle related information such as fuel level, total distance covered, brake fuel level, oil level, door open/close, air filter information, etc.) to the vehicle 1000. For example, the infotainment SoC 1030 may radios, disk players, navigation systems, video players, USB and Bluetooth connectivity, carputers, in-car entertainment, Wi-Fi, steering wheel audio controls, hands free voice control, a heads-up display (HUD), an HMI display 1034, a telematics device, a control panel (e.g., for controlling and/or interacting with various components, features, and/or systems), and/or other components. The infotainment SoC 1030 may further be used to provide information (e.g., visual and/or audible) to a user(s) of the vehicle, such as information from the ADAS system 1038, autonomous driving information such as planned vehicle maneuvers, trajectories, surrounding environment information (e.g., intersection information, vehicle information, road information, etc.), and/or other information.

The infotainment SoC 1030 may include GPU functionality. The infotainment SoC 1030 may communicate over the bus 1002 (e.g., CAN bus, Ethernet, etc.) with other devices, systems, and/or components of the vehicle 1000. In some examples, the infotainment SoC 1030 may be coupled to a supervisory MCU such that the GPU of the infotainment system may perform some self-driving functions in the event that the primary controller(s) 1036 (e.g., the primary and/or backup computers of the vehicle 1000) fail. In such an example, the infotainment SoC 1030 may put the vehicle 1000 into a chauffeur to safe stop mode, as described herein.

The vehicle 1000 may further include an instrument cluster 1032 (e.g., a digital dash, an electronic instrument cluster, a digital instrument panel, etc.). The instrument cluster 1032 may include a controller and/or supercomputer (e.g., a discrete controller or supercomputer). The instrument cluster 1032 may include a set of instrumentation such as a speedometer, fuel level, oil pressure, tachometer, odometer, turn indicators, gearshift position indicator, seat belt warning light(s), parking-brake warning light(s), engine-malfunction light(s), airbag (SRS) system information, lighting controls, safety system controls, navigation information, etc. In some examples, information may be displayed and/or shared among the infotainment SoC 1030 and the instrument cluster 1032. In other words, the instrument cluster 1032 may be included as part of the infotainment SoC 1030, or vice versa.

FIG. 10D is a system diagram for communication between cloud-based server(s) and the example autonomous vehicle 1000 of FIG. 10A, in accordance with some embodiments of the present disclosure. The system 1076 may include server(s) 1078, network(s) 1090, and vehicles, including the vehicle 1000. The server(s) 1078 may include a plurality of GPUs 1084(A)-1084 (H) (collectively referred to herein as GPUs 1084), PCIe switches 1082(A)-1082(H) (collectively referred to herein as PCIe switches 1082), and/or CPUs 1080(A)-1080(B) (collectively referred to herein as CPUs 1080). The GPUs 1084, the CPUs 1080, and the PCIe switches may be interconnected with high-speed interconnects such as, for example and without limitation, NVLink interfaces 1088 developed by NVIDIA and/or PCIe connections 1086. In some examples, the GPUs 1084 are connected via NVLink and/or NVSwitch SoC and the GPUs 1084 and the PCIe switches 1082 are connected via PCIe interconnects. Although eight GPUs 1084, two CPUs 1080, and two PCIe switches are illustrated, this is not intended to be limiting. Depending on the embodiment, each of the server(s) 1078 may include any number of GPUs 1084, CPUs 1080, and/or PCIe switches. For example, the server(s) 1078 may each include eight, sixteen, thirty-two, and/or more GPUs 1084.

The server(s) 1078 may receive, over the network(s) 1090 and from the vehicles, image data representative of images showing unexpected or changed road conditions, such as recently commenced road-work. The server(s) 1078 may transmit, over the network(s) 1090 and to the vehicles, neural networks 1092, updated neural networks 1092, and/or map information 1094, including information regarding traffic and road conditions. The updates to the map information 1094 may include updates for the HD map 1022, such as information regarding construction sites, potholes, detours, flooding, and/or other obstructions. In some examples, the neural networks 1092, the updated neural networks 1092, and/or the map information 1094 may have resulted from new training and/or experiences represented in data received from any number of vehicles in the environment, and/or based on training performed at a datacenter (e.g., using the server(s) 1078 and/or other servers).

The server(s) 1078 may be used to train machine learning models (e.g., neural networks) based on training data. The training data may be generated by the vehicles, and/or may be generated in a simulation (e.g., using a game engine). In some examples, the training data is tagged (e.g., where the neural network benefits from supervised learning) and/or undergoes other pre-processing, while in other examples the training data is not tagged and/or pre-processed (e.g., where the neural network does not require supervised learning). Training may be executed according to any one or more classes of machine learning techniques, including, without limitation, classes such as: supervised training, semi-supervised training, unsupervised training, self-learning, reinforcement learning, federated learning, transfer learning, feature learning (including principal component and cluster analyses), multi-linear subspace learning, manifold learning, representation learning (including spare dictionary learning), rule-based machine learning, anomaly detection, and any variants or combinations therefor. Once the machine learning models are trained, the machine learning models may be used by the vehicles (e.g., transmitted to the vehicles over the network(s) 1090, and/or the machine learning models may be used by the server(s) 1078 to remotely monitor the vehicles.

In some examples, the server(s) 1078 may receive data from the vehicles and apply the data to up-to-date real-time neural networks for real-time intelligent inferencing. The server(s) 1078 may include deep-learning supercomputers and/or dedicated AI computers powered by GPU(s) 1084, such as a DGX and DGX Station machines developed by NVIDIA. However, in some examples, the server(s) 1078 may include deep learning infrastructure that use only CPU-powered datacenters.

The deep-learning infrastructure of the server(s) 1078 may be capable of fast, real-time inferencing, and may use that capability to evaluate and verify the health of the processors, software, and/or associated hardware in the vehicle 1000. For example, the deep-learning infrastructure may receive periodic updates from the vehicle 1000, such as a sequence of images and/or objects that the vehicle 1000 has located in that sequence of images (e.g., via computer vision and/or other machine learning object classification techniques). The deep-learning infrastructure may run its own neural network to identify the objects and compare them with the objects identified by the vehicle 1000 and, if the results do not match and the infrastructure concludes that the AI in the vehicle 1000 is malfunctioning, the server(s) 1078 may transmit a signal to the vehicle 1000 instructing a fail-safe computer of the vehicle 1000 to assume control, notify the passengers, and complete a safe parking maneuver.

For inferencing, the server(s) 1078 may include the GPU(s) 1084 and one or more programmable inference accelerators (e.g., NVIDIA's TensorRT). The combination of GPU-powered servers and inference acceleration may make real-time responsiveness possible. In other examples, such as where performance is less critical, servers powered by CPUs, FPGAs, and other processors may be used for inferencing.

### Example Computing Device

FIG. 11 is a block diagram of an example computing device(s) 1100 suitable for use in implementing some embodiments of the present disclosure. Computing device 1100 may include an interconnect system 1102 that directly or indirectly couples the following devices: memory 1104, one or more central processing units (CPUs) 1106, one or more graphics processing units (GPUs) 1108, a communication interface 1110, input/output (I/O) ports 1112, input/output components 1114, a power supply 1116, one or more presentation components 1118 (e.g., display(s)), and one or more logic units 1120. In at least one embodiment, the computing device(s) 1100 may comprise one or more virtual machines (VMs), and/or any of the components thereof may comprise virtual components (e.g., virtual hardware components). For non-limiting examples, one or more of the GPUs 1108 may comprise one or more vGPUs, one or more of the CPUs 1106 may comprise one or more vCPUs, and/or one or more of the logic units 1120 may comprise one or more virtual logic units. As such, a computing device(s) 1100 may include discrete components (e.g., a full GPU dedicated to the computing device 1100), virtual components (e.g., a portion of a GPU dedicated to the computing device 1100), or a combination thereof.

Although the various blocks of FIG. 11 are shown as connected via the interconnect system 1102 with lines, this is not intended to be limiting and is for clarity only. For example, in some embodiments, a presentation component 1118, such as a display device, may be considered an I/O component 1114 (e.g., if the display is a touch screen). As another example, the CPUs 1106 and/or GPUs 1108 may include memory (e.g., the memory 1104 may be representative of a storage device in addition to the memory of the GPUs 1108, the CPUs 1106, and/or other components). In other words, the computing device of FIG. 11 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 11.

The interconnect system 1102 may represent one or more links or busses, such as an address bus, a data bus, a control bus, or a combination thereof. The interconnect system 1102 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1106 may be directly connected to the memory 1104. Further, the CPU 1106 may be directly connected to the GPU 1108. Where there is direct, or point-to-point connection between components, the interconnect system 1102 may include a PCIe link to carry out the connection. In these examples, a PCI bus need not be included in the computing device 1100.

The memory 1104 may include any of a variety of computer-readable media. The computer-readable media may be any available media that may be accessed by the computing device 1100. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1104 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1100. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1106 may be configured to execute at least some of the computer-readable instructions to control one or more components of the computing device 1100 to perform one or more of the methods and/or processes described herein. The CPU(s) 1106 may each include one or more cores (e.g., one, two, four, eight, twenty-eight, seventy-two, etc.) that are capable of handling a multitude of software threads simultaneously. The CPU(s) 1106 may include any type of processor, and may include different types of processors depending on the type of computing device 1100 implemented (e.g., processors with fewer cores for mobile devices and processors with more cores for servers). For example, depending on the type of computing device 1100, the processor may be an Advanced RISC Machines (ARM) processor implemented using Reduced Instruction Set Computing (RISC) or an x86 processor implemented using Complex Instruction Set Computing (CISC). The computing device 1100 may include one or more CPUs 1106 in addition to one or more microprocessors or supplementary co-processors, such as math co-processors.

In addition to or alternatively from the CPU(s) 1106, the GPU(s) 1108 may be configured to execute at least some of the computer-readable instructions to control one or more components of the computing device 1100 to perform one or more of the methods and/or processes described herein. One or more of the GPU(s) 1108 may be an integrated GPU (e.g., with one or more of the CPU(s) 1106 and/or one or more of the GPU(s) 1108 may be a discrete GPU. In embodiments, one or more of the GPU(s) 1108 may be a coprocessor of one or more of the CPU(s) 1106. The GPU(s) 1108 may be used by the computing device 1100 to render graphics (e.g., 3D graphics) or perform general purpose computations. For example, the GPU(s) 1108 may be used for General-Purpose computing on GPUs (GPGPU). The GPU(s) 1108 may include hundreds or thousands of cores that are capable of handling hundreds or thousands of software threads simultaneously. The GPU(s) 1108 may generate pixel data for output images in response to rendering commands (e.g., rendering commands from the CPU(s) 1106 received via a host interface). The GPU(s) 1108 may include graphics memory, such as display memory, for storing pixel data or any other suitable data, such as GPGPU data. The display memory may be included as part of the memory 1104. The GPU(s) 1108 may include two or more GPUs operating in parallel (e.g., via a link). The link may directly connect the GPUs (e.g., using NVLINK) or may connect the GPUs through a switch (e.g., using NVSwitch). When combined together, each GPU 1108 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1106 and/or the GPU(s) 1108, the logic unit(s) 1120 may be configured to execute at least some of the computer-readable instructions to control one or more components of the computing device 1100 to perform one or more of the methods and/or processes described herein. In embodiments, the CPU(s) 1106, the GPU(s) 1108, and/or the logic unit(s) 1120 may discretely or jointly perform any combination of the methods, processes and/or portions thereof. One or more of the logic units 1120 may be part of and/or integrated in one or more of the CPU(s) 1106 and/or the GPU(s) 1108 and/or one or more of the logic units 1120 may be discrete components or otherwise external to the CPU(s) 1106 and/or the GPU(s) 1108. In embodiments, one or more of the logic units 1120 may be a coprocessor of one or more of the CPU(s) 1106 and/or one or more of the GPU(s) 1108.

Examples of the logic unit(s) 1120 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1110 may include one or more receivers, transmitters, and/or transceivers that enable the computing device 1100 to communicate with other computing devices via an electronic communication network, included wired and/or wireless communications. The communication interface 1110 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1120 and/or communication interface 1110 may include one or more data processing units (DPUs) to transmit data received over a network and/or through interconnect system 1102 directly to (e.g., a memory of) one or more GPU(s) 1108.

The I/O ports 1112 may enable the computing device 1100 to be logically coupled to other devices including the I/O components 1114, the presentation component(s) 1118, and/or other components, some of which may be built in to (e.g., integrated in) the computing device 1100. Illustrative I/O components 1114 include a microphone, mouse, keyboard, joystick, game pad, game controller, satellite dish, scanner, printer, wireless device, etc. The I/O components 1114 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1100. The computing device 1100 may be include depth cameras, such as stereoscopic camera systems, infrared camera systems, RGB camera systems, touchscreen technology, and combinations of these, for gesture detection and recognition. Additionally, the computing device 1100 may include accelerometers or gyroscopes (e.g., as part of an inertia measurement unit (IMU)) that enable detection of motion. In some examples, the output of the accelerometers or gyroscopes may be used by the computing device 1100 to render immersive augmented reality or virtual reality.

The power supply 1116 may include a hard-wired power supply, a battery power supply, or a combination thereof. The power supply 1116 may provide power to the computing device 1100 to enable the components of the computing device 1100 to operate.

The presentation component(s) 1118 may include a display (e.g., a monitor, a touch screen, a television screen, a heads-up-display (HUD), other display types, or a combination thereof), speakers, and/or other presentation components. The presentation component(s) 1118 may receive data from other components (e.g., the GPU(s) 1108, the CPU(s) 1106, DPUs, etc.), and output the data (e.g., as an image, video, sound, etc.).

### Example Data Center

FIG. 12 illustrates an example data center 1200 that may be used in at least one embodiments of the present disclosure. The data center 1200 may include a data center infrastructure layer 1210, a framework layer 1220, a software layer 1230, and/or an application layer 1240.

As shown in FIG. 12, the data center infrastructure layer 1210 may include a resource orchestrator 1212, grouped computing resources 1214, and node computing resources (“node C.R.s”) 1216(1)-1216(N), where “N” represents any whole, positive integer. In at least one embodiment, node C.R.s 1216(1)-1216(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1216(1)-1216(N) may correspond to a server having one or more of the above-mentioned computing resources. In addition, in some embodiments, the node C.R.s 1216(1)-12161 (N) may include one or more virtual components, such as vGPUs, vCPUs, and/or the like, and/or one or more of the node C.R.s 1216(1)-1216(N) may correspond to a virtual machine (VM).

In at least one embodiment, grouped computing resources 1214 may include separate groupings of node C.R.s 1216 housed within one or more racks (not shown), or many racks housed in data centers at various geographical locations (also not shown). Separate groupings of node C.R.s 1216 within grouped computing resources 1214 may include grouped compute, network, memory or storage resources that may be configured or allocated to support one or more workloads. In at least one embodiment, several node C.R.s 1216 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1212 may configure or otherwise control one or more node C.R.s 1216(1)-1216(N) and/or grouped computing resources 1214. In at least one embodiment, resource orchestrator 1212 may include a software design infrastructure (SDI) management entity for the data center 1200. The resource orchestrator 1212 may include hardware, software, or some combination thereof.

In at least one embodiment, as shown in FIG. 12, framework layer 1220 may include a job scheduler 1233, a configuration manager 1234, a resource manager 1236, and/or a distributed file system 1238. The framework layer 1220 may include a framework to support software 1232 of software layer 1230 and/or one or more application(s) 1242 of application layer 1240. The software 1232 or application(s) 1242 may respectively include web-based service software or applications, such as those provided by Amazon Web Services, Google Cloud and Microsoft Azure. The framework layer 1220 may be, but is not limited to, a type of free and open-source software web application framework such as Apache Spark™ (hereinafter “Spark”) that may utilize distributed file system 1238 for large-scale data processing (e.g., “big data”). In at least one embodiment, job scheduler 1233 may include a Spark driver to facilitate scheduling of workloads supported by various layers of data center 1200. The configuration manager 1234 may be capable of configuring different layers such as software layer 1230 and framework layer 1220 including Spark and distributed file system 1238 for supporting large-scale data processing. The resource manager 1236 may be capable of managing clustered or grouped computing resources mapped to or allocated for support of distributed file system 1238 and job scheduler 1233. In at least one embodiment, clustered or grouped computing resources may include grouped computing resource 1214 at data center infrastructure layer 1210. The resource manager 1236 may coordinate with resource orchestrator 1212 to manage these mapped or allocated computing resources.

In at least one embodiment, software 1232 included in software layer 1230 may include software used by at least portions of node C.R.s 1216(1)-1216(N), grouped computing resources 1214, and/or distributed file system 1238 of framework layer 1220. One or more types of software may include, but are not limited to, Internet web page search software, e-mail virus scan software, database software, and streaming video content software.

In at least one embodiment, application(s) 1242 included in application layer 1240 may include one or more types of applications used by at least portions of node C.R.s 1216(1)-1216(N), grouped computing resources 1214, and/or distributed file system 1238 of framework layer 1220. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1234, resource manager 1236, and resource orchestrator 1212 may implement any number and type of self-modifying actions based on any amount and type of data acquired in any technically feasible fashion. Self-modifying actions may relieve a data center operator of data center 1200 from making possibly bad configuration decisions and possibly avoiding underutilized and/or poor performing portions of a data center.

The data center 1200 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1200. In at least one embodiment, trained or deployed machine learning models corresponding to one or more neural networks may be used to infer or predict information using resources described above with respect to the data center 1200 by using weight parameters calculated through one or more training techniques, such as but not limited to those described herein.

In at least one embodiment, the data center 1200 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1100 of FIG. 11—e.g., each device may include similar components, features, and/or functionality of the computing device(s) 1100. In addition, where backend devices (e.g., servers, NAS, etc.) are implemented, the backend devices may be included as part of a data center 1200, an example of which is described in more detail herein with respect to FIG. 12.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1100 described herein with respect to FIG. 11. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Paragraphs

A: A method comprising: obtaining, during one or more drives, data associated with a traffic feature located within an environment; determining, based at least on map data, one or more candidate lines associated with the traffic feature; determining, based at least on the one or more drives, that a candidate line of the one or more candidate lines includes a wait line for the traffic feature; and updating the map data to indicate that the candidate line includes the wait line for the traffic feature.

B: The method of paragraph A, further comprising: determining one or more rules associated with the traffic feature and determining, based at least on the one or more rules, one or more scores associated with the one or more drives, wherein the determining that the candidate line includes the wait line for the traffic feature is further based at least on the one or more scores.

C: The method of paragraph B, wherein the determining the one or more scores associated with the one or more drives comprises one or more of: determining a first score associated with a first drive based at least on a first machine associated with the first drive following the one or more rules; or determining a second score associated with a second drive based at least on a second machine associated with the second drive not following the one or more rules, wherein the second score is less than the first score.

D: The method of paragraph B, wherein: the one or more drives include a plurality of drives associated with the traffic feature; the one or more scores include a plurality of scores associated with the plurality of drives; the method further comprises determining, based at least on removing a first portion of the plurality of drives that are associated with a portion of the plurality of scores that are less than a threshold score, a second portion of the plurality of drives; and the determining that the candidate line includes the wait line is based at least on the second portion of the plurality of drives.

E: The method of any one of paragraphs A-D, further comprising: determining that the one or more drives are associated with a lane of one or more lanes located within the environment; and determining a group of drives based at least on merging the one or more drives that are associated with the lane, wherein the determining that the candidate line includes the wait line for the traffic feature is based at least on the group of drives.

F: The method of any one of paragraphs A-E, further comprising: determining, based at least on the map data, that the one or more candidate lines are associated with a same lane as the traffic feature, wherein the determining the one or more candidate lines associated with the traffic feature is based at least on the one or more candidate lines being associated with the same lane as the traffic feature.

G: The method of any one of paragraphs A-F, further comprising: determining, based at least on the map data, that the one or more candidate lines are located within a threshold distance to the traffic feature, wherein the determining the one or more candidate lines associated with the traffic feature is based at least on the one or more candidate lines being located within the threshold distance to the traffic feature.

H: The method of any one of paragraphs A-G, wherein: the traffic feature comprises one or more of: a traffic signal; a stop sign; a crosswalk light; a crosswalk sign; a train crossing light; a train crossing sign; a yield sign; or a stop light; and the one or more candidate lines comprise one or more of: a stop line; a crosswalk line; an intersection entrance line; an intersection exit line; a train crossing line; or a yield line.

I: The method of any one of paragraphs A-H, further comprising sending the map data as updated to one or more machines navigating within the environment, wherein the map data causes the one or more machines to stop at the wait line when approaching the traffic feature.

J: A system comprising: one or more processors to: determine, based at least on map data, a traffic feature located within an environment; obtain data representative of one or more drives associated with the traffic feature; determine, based at least on the one or more drives, a wait line associated with the traffic feature; and update the map data to indicate that the wait line associated with the traffic feature.

K: The system of paragraph J, wherein the one or more processors are further to: determine, based at least on the map data, one or more candidate lines associated with the traffic feature, wherein the determination of the wait line comprises determining, based at least on the one or more drives, that a candidate line of the one or more candidate lines includes the wait line associated with the traffic feature.

L: The system of paragraph K, wherein the one or more processors are further to: determine, based at least on the map data, that the one or more candidate lines are located within a threshold distance to the traffic feature, wherein the determination of the one or more candidate lines associated with the traffic feature is based at least on the one or more candidate lines being within the threshold distance to the traffic feature.

M: The system of any one of paragraphs J-L, wherein the one or more processors are further to: determine, based at least on the one or more drives, one or more locations within the environment that one or more machines associated with the one or more drives stop at when approaching the traffic feature, wherein the determination of the wait line comprises determining the wait line associated with the traffic feature based at least on the one or more locations.

N: The system of any one of paragraphs J-M, wherein the one or more processors are further to: determine one or more rules associated with the traffic feature; and determine, based at least on the one or more rules, one or more scores associated with the one or more drives, wherein the determination of the wait line associated with the traffic feature is further based at least on the one or more scores.

O: The system of paragraph N, wherein the determination of the one or more scores associated with the one or more drives comprises one or more of: determining a first score associated with a first drive based at least on a first machine associated with the first drive following the one or more rules; or determining a second score associated with a second drive based at least on a second machine associated with the second drive not following the one or more rules, wherein the second score is less than the first score.

P: The system of paragraph N, wherein: the one or more drives include a plurality of drives associated with the traffic feature; the one or more scores include a plurality of scores associated with the plurality of drives; the one or more processors are further to determine, based at least on removing a first portion of the plurality of drives that are associated with a portion of the plurality of scores that are less than a threshold score, a second portion of the plurality of drives; and the determination of the wait line associated with the traffic feature is based at least on the second portion of the plurality of drives.

Q: The system of any one of paragraphs J-P, wherein the one or more processors are further to: determine that the one or more drives are associated with a lane of one or more lanes located within the environment; and determine a group of drives based at least on merging the one or more drives that are associated with the lane, wherein the determination of the wait line associated with the traffic feature is based at least on the group of drives.

R: The system of any one of paragraphs J-Q, wherein the system is comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

S: One or more processors comprising: processing circuitry to update map data to indicate that a candidate line of one or more candidate lines associated with a traffic feature located within an environment includes a wait line associated with the traffic feature, wherein the candidate line is selected as including the wait line based at least on one or more drives associated with one or more machines navigating within the environment and through an intersection associated with the traffic feature.

T: The one or more processors of paragraph S, wherein the one or more processors are comprised in at least one of: a control system for an autonomous or semi-autonomous machine; a perception system for an autonomous or semi-autonomous machine; a system for performing one or more simulation operations; a system for performing one or more digital twin operations; a system for performing light transport simulation; a system for performing collaborative content creation for 3D assets; a system for performing one or more deep learning operations; a system implemented using an edge device; a system implemented using a robot; a system for performing one or more generative AI operations; a system for performing operations using one or more large language models (LLMs); a system for performing one or more conversational AI operations; a system for generating synthetic data; a system for presenting at least one of virtual reality content, augmented reality content, or mixed reality content; a system incorporating one or more virtual machines (VMs); a system implemented at least partially in a data center; or a system implemented at least partially using cloud computing resources.

Any, some and/or all features in one aspect of the disclosure may be applied to other aspects of the disclosure, in any appropriate combination or sub-combination. In particular, device aspects may be applied to method aspects, and vice versa. It should also be appreciated that particular combinations of the various features described and defined in any aspect or embodiment of the disclosure can be implemented and/or supplied and/or used independently.

The various features described in the description as optional—such as by use of “may” or “can”—may be combined into a single embodiment, and/or any combination of the features may be combined to form various embodiments that rely on the combination of these various optional features.

What is claimed is:

1. A method comprising:
obtaining, during one or more drives, data associated with a traffic feature located within an environment;
determining, based at least on map data, one or more candidate lines associated with the traffic feature;
determining, based at least on the one or more drives, that a candidate line of the one or more candidate lines includes a wait line for the traffic feature; and
updating the map data to indicate that the candidate line includes the wait line for the traffic feature.

2. The method of claim 1, further comprising:
determining one or more rules associated with the traffic feature; and
determining, based at least on the one or more rules, one or more scores associated with the one or more drives,
wherein the determining that the candidate line includes the wait line for the traffic feature is further based at least on the one or more scores.

3. The method of claim 2, wherein the determining the one or more scores associated with the one or more drives comprises one or more of:
determining a first score associated with a first drive based at least on a first machine associated with the first drive following the one or more rules; or
determining a second score associated with a second drive based at least on a second machine associated with the second drive not following the one or more rules, wherein the second score is less than the first score.

4. The method of claim 2, wherein:
the one or more drives include a plurality of drives associated with the traffic feature;
the one or more scores include a plurality of scores associated with the plurality of drives;
the method further comprises determining, based at least on removing a first portion of the plurality of drives that are associated with a portion of the plurality of scores that are less than a threshold score, a second portion of the plurality of drives; and
the determining that the candidate line includes the wait line is based at least on the second portion of the plurality of drives.

5. The method of claim 1, further comprising:
determining that the one or more drives are associated with a lane of one or more lanes located within the environment; and
determining a group of drives based at least on merging the one or more drives that are associated with the lane,
wherein the determining that the candidate line includes the wait line for the traffic feature is based at least on the group of drives.

6. The method of claim 1, further comprising:
determining, based at least on the map data, that the one or more candidate lines are associated with a same lane as the traffic feature,
wherein the determining the one or more candidate lines associated with the traffic feature is based at least on the one or more candidate lines being associated with the same lane as the traffic feature.

7. The method of claim 1, further comprising:
determining, based at least on the map data, that the one or more candidate lines are located within a threshold distance to the traffic feature,
wherein the determining the one or more candidate lines associated with the traffic feature is based at least on the one or more candidate lines being located within the threshold distance to the traffic feature.

8. The method of claim 1, wherein:
the traffic feature comprises one or more of:
a traffic signal;
a stop sign;
a crosswalk light;
a crosswalk sign;
a train crossing light;
a train crossing sign;
a yield sign; or
a stop light; and
the one or more candidate lines comprise one or more of:
a stop line;
a crosswalk line;
an intersection entrance line;
an intersection exit line;
a train crossing line; or
a yield line.

9. The method of claim 1, further comprising sending the map data as updated to one or more machines navigating within the environment, wherein the map data causes the one or more machines to stop at the wait line when approaching the traffic feature.

10. A system comprising:
one or more processors to:
determine, based at least on map data, a traffic feature located within an environment;
obtain data representative of one or more drives associated with the traffic feature;
determine, based at least on the one or more drives, a wait line associated with the traffic feature; and
update the map data to indicate that the wait line associated with the traffic feature.

11. The system of claim 10, wherein the one or more processors are further to:
determine, based at least on the map data, one or more candidate lines associated with the traffic feature,
wherein the determination of the wait line comprises determining, based at least on the one or more drives, that a candidate line of the one or more candidate lines includes the wait line associated with the traffic feature.

12. The system of claim 11, wherein the one or more processors are further to:
determine, based at least on the map data, that the one or more candidate lines are located within a threshold distance to the traffic feature,
wherein the determination of the one or more candidate lines associated with the traffic feature is based at least on the one or more candidate lines being within the threshold distance to the traffic feature.

13. The system of claim 10, wherein the one or more processors are further to:
determine, based at least on the one or more drives, one or more locations within the environment that one or more machines associated with the one or more drives stop at when approaching the traffic feature,
wherein the determination of the wait line comprises determining the wait line associated with the traffic feature based at least on the one or more locations.

14. The system of claim 10, wherein the one or more processors are further to:
determine one or more rules associated with the traffic feature; and
determine, based at least on the one or more rules, one or more scores associated with the one or more drives,
wherein the determination of the wait line associated with the traffic feature is further based at least on the one or more scores.

15. The system of claim 14, wherein the determination of the one or more scores associated with the one or more drives comprises one or more of:
determining a first score associated with a first drive based at least on a first machine associated with the first drive following the one or more rules; or
determining a second score associated with a second drive based at least on a second machine associated with the second drive not following the one or more rules, wherein the second score is less than the first score.

16. The system of claim 14, wherein:
the one or more drives include a plurality of drives associated with the traffic feature;
the one or more scores include a plurality of scores associated with the plurality of drives;
the one or more processors are further to determine, based at least on removing a first portion of the plurality of drives that are associated with a portion of the plurality of scores that are less than a threshold score, a second portion of the plurality of drives; and
the determination of the wait line associated with the traffic feature is based at least on the second portion of the plurality of drives.

17. The system of claim 10, wherein the one or more processors are further to:
determine that the one or more drives are associated with a lane of one or more lanes located within the environment; and
determine a group of drives based at least on merging the one or more drives that are associated with the lane,
wherein the determination of the wait line associated with the traffic feature is based at least on the group of drives.

18. The system of claim 10, wherein the system is comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.

19. One or more processors comprising:
processing circuitry to update map data to indicate that a candidate line of one or more candidate lines associated with a traffic feature located within an environment includes a wait line associated with the traffic feature, wherein the candidate line is selected as including the wait line based at least on one or more drives associated with one or more machines navigating within the environment and through an intersection associated with the traffic feature.

20. The one or more processors of claim 19, wherein the one or more processors are comprised in at least one of:
a control system for an autonomous or semi-autonomous machine;
a perception system for an autonomous or semi-autonomous machine;
a system for performing one or more simulation operations;
a system for performing one or more digital twin operations;
a system for performing light transport simulation;
a system for performing collaborative content creation for 3D assets;
a system for performing one or more deep learning operations;
a system implemented using an edge device;
a system implemented using a robot;
a system for performing one or more generative AI operations;
a system for performing operations using one or more large language models (LLMs);
a system for performing one or more conversational AI operations;
a system for generating synthetic data;
a system for presenting at least one of virtual reality content, augmented reality content, or mixed reality content;
a system incorporating one or more virtual machines (VMs);
a system implemented at least partially in a data center; or
a system implemented at least partially using cloud computing resources.
